(19) United States
(12) Patent Application Publication
(10) Pub. No.: US 2023/0399588 A1
(43) Pub. Date: Dec. 14, 2023

(54) USE OF LIPOXYGENASE

(71) Applicant: Novozymes A/S, Bagsvaerd (DK)

(72) Inventor: Iben Damager, Vaerloese (DK)

(73) Assignee: Novozymes A/S, Bagsvaerd (DK)

(21) Appl. No.: 18/034,559

(22) PCT Filed: Oct. 27, 2021
(86) PCT No.: PCT/EP2021/079842

§ 371 Date: Apr. 28, 2023

(30) Foreign Application Priority Data
Oct. 28, 2020 (EP) 20204277.6

(51) Int. Cl. C11D 3/386; C11D 11/00; C11D 1/83; C11D 3/20

(52) U.S. Cl. CPC C11D 3/38636; C11D 11/0017; C11D 1/83; C11D 3/38627; C11D 3/2079; C11D 1/22

(57) ABSTRACT

The present invention concerns use of a lipoxygenase for bleaching or removing a stain from a surface, wherein the wash liquor comprises a reduced detergent level.

### REFERENCE TO A SEQUENCE LISTING

This application contains a Sequence Listing in computer readable form, which is incorporated herein by reference.

### FIELD OF THE INVENTION

The present invention concerns use of a lipoxygenase for bleaching or removing a stain from a surface by laundering or dish wash, wherein the wash liquor comprises a reduced detergent level. In a further aspect the invention relates to detergent composition comprising a lipoxygenase and a biosurfactant.

### BACKGROUND OF INVENTION

The ability of a detergent to remove stains from the surface of textiles is an obvious care-about for the customer and various surfactant ingredients play a role in that process. However, there is a desire to reduce the amount of detergents used in household care for a number of reasons. One reason is that some of the ingredients in detergents are derived from petrochemical resources and face scrutiny due to environmental concerns, most of all for not being sustainable because they are from a non-renewable source and are poorly biodegradable or even persistent in the environment. Another reason is that lowering the detergent concentration in the wash liquor may reduce production cost and will ultimately lead to less transportation of detergents and consequently less burden on the environment. This trend toward compaction of detergents and reduced in-wash concentration of surfactants requires the development of solutions to ensure continued performance of the detergents, including new enzymes and new use of enzymes.

EP3483243 (Procter & Gamble) discloses detergent composition comprising the lipoxygenase of SEQ ID NO 1 of the present invention (designated as SEQ ID NO 57 in EP3483243).

WO2014/090940 (Novozymes) discloses detergent composition comprising the lipoxygenase of SEQ ID NO 1 of the present invention (designated as SEQ ID NO 3 in WO2014/090940).

None of the prior art documents disclose the improved effect of a lipoxygenase for bleaching or removing a stain by laundering or dish wash, wherein the wash liquor comprises a reduced detergent level.

### SUMMARY OF THE INVENTION

Lipoxygenase only showed limited stain bleaching effect in previous wash tests when detergents were applied at full dosage. The inventors have now surprisingly found that lipoxygenase has a very good performance on stain bleaching in wash when the detergent is dosed at reduced levels. The present invention makes it possible to use lipoxygenase in detergents with good benefit and allows at same time for a significant reduction of the in-wash detergent load. Accordingly, the present invention discloses use of a polypeptide having lipoxygenase activity for bleaching or removing a stain on textile in a wash liquor, wherein the wash liquor comprises from about 0 g detergent/L wash liquor to about 4 g detergent/L wash liquor, and optionally one or more additional enzymes.

In a further aspect the invention relates to detergent composition comprising a lipoxygenase and one or more biosurfactants.

### Definitions

In accordance with this detailed description, the following definitions apply. Note that the singular forms “a,” “an,” and “the” include plural references unless the context clearly dictates otherwise. Unless defined otherwise or clearly indicated by context, all technical and scientific terms used herein have the same meaning as commonly understood by one of ordinary skill in the art to which this invention belongs.

AEP (active enzyme protein): Enzyme protein which has a catalytic activity. There are various way to determine AEP. For example, AEP can be calculated by dividing total activities by the enzyme's specific activity

Bacterial: The term “bacterial” in relation to polypeptide (such as an enzyme, e.g. a lipoxygenase) refers to a polypeptide encoded by and thus directly derivable from the genome of a bacteria, where such bacteria has not been genetically modified to encode said polypeptide, e.g. by introducing the encoding sequence in the genome by recombinant DNA technology. In the context of the present invention, the term “bacterial lipoxygenease” or “polypeptide having lipoxygenase activity obtained from a bacterial source” or “polypeptide is of bacterial origin” thus refers to a lipoxygenase encoded by and thus directly derivable from the genome of a bacterial species, where the bacterial species has not been subjected to a genetic modification introducing recombinant DNA encoding said lipoxygenase. A sequence encoding a bacterial polypeptide having lipoxygenase activity may also be referred to as a wildtype lipoxygenase (or parent lipoxygenase). Bacterial polypeptide having lipoxygenase activity includes recombinant produced wild types. In a further aspect, the invention provides polypeptides having lipoxygenase activity, wherein said polypeptides are substantially homologous to a bacterial lipoxygenase. In the context of the present invention, the term “substantially homologous” denotes a polypeptide having lipoxygenase activity which is at least 80%, preferably at least 85%, more preferably at least 90%, more preferably at least 95%, even more preferably at least 96%, 97%, 98%, and most preferably at least 99% identical to the amino acid sequence of a selected bacterial lipoxygenase.

Biosurfactants: Biosurfactants are active compounds that are produced at the microbial cell surface or excreted and reduce surface and interfacial tension. Microbial surfactants offer several advantages over synthetic ones, such as low toxicity and high biodegradability, and often remain active at extreme pH and salinity. Biosurfactants are produced by bacteria, yeasts, and filamentous fungi and are generally classified into low molecular-mass molecules (lipopeptides, glycolipids) and high molecular-mass polymers (polymeric and particulate surfactants). Biosurfactants include but are not limited to rhamnolipids and sophorolipids.

Biosurfactants may also be obtained from plants rather than traditional petrochemical processes and include, but are not limited to, SLS, APG, AEO and SLES.

Detergent adjunct ingredient: The detergent adjunct ingredient is different to the lipoxygenase of this invention. The precise nature of these additional adjunct components, and levels of incorporation thereof, will depend on the physical form of the composition and the nature of the operation for which it is to be used. Suitable adjunct materials include, but are not limited to the components described below such as surfactants, builders, flocculating aid, chelating agents, dye transfer inhibitors, enzymes, enzyme stabilizers, enzyme inhibitors, catalytic materials, bleach activators, hydrogen peroxide, sources of hydrogen peroxide, preformed peracids, s, s, brighteners, suds suppressors, dyes, perfumes, structure elasticizing agents, fabric softeners, carriers, hydrotropes, builders and co-builders, fabric hueing agents, anti-foaming agents, dispersants, processing aids, solvents, and/or pigments.

Detergent composition: The term “detergent composition” refers to compositions that find use in the removal of undesired compounds from items to be cleaned, such as textiles. The detergent composition may be used to e.g. clean textiles for both household cleaning and industrial cleaning. The terms encompass any materials/compounds selected for the particular type of cleaning composition desired and the form of the product (e.g., liquid, gel, powder, granulate, paste, bar, or spray compositions) and includes, but is not limited to, detergent compositions (e.g., liquid and/or solid laundry detergents and fine fabric detergents; fabric fresheners; fabric softeners; laundry boosters; and textile and laundry pre-spotters/pre-treatment). In addition to containing the enzyme of the invention, the detergent formulation may contain one or more additional enzymes (such as proteases, amylases, lipases, cutinases, cellulases, endoglucanases, xyloglucanases, pectinases, pectin lyases, xanthanases, peroxidases, haloperoxygenases, catalases and mannanases, or any mixture thereof), and/or detergent adjunct ingredients such as surfactants, builders, chelators or chelating agents, bleach system or bleach components, polymers (as set forth herein), fabric conditioners, foam boosters, suds suppressors, dyes, perfume, tannish inhibitors, optical brighteners, bactericides, fungicides, soil suspending agents, anti-corrosion agents, enzyme inhibitors or stabilizers, enzyme activators, bluing agents and fluorescent dyes, antioxidants, and solubilizers.

Detergent load is the amount of detergent used in a wash cycle.

Enzyme detergency benefit: The term “enzyme detergency benefit” is defined herein as the advantageous effect an enzyme may add to a detergent compared to the same detergent without the enzyme. Important detergency benefits which can be provided by enzymes are stain removal with no or very little visible soils after washing and/or cleaning, prevention or reduction of redeposition of soils released in the washing process (an effect that also is termed anti-redeposition), restoring fully or partly the whiteness of textiles which originally were white but after repeated use and wash have obtained a greyish or yellowish appearance (an effect that also is termed whitening). Also included is the maintenance of whiteness, e.g., the prevention of greying or dullness. Textile care benefits, which are not directly related to catalytic stain removal or prevention of redeposition of soils, are also important for enzyme detergency benefits. Examples of such textile care benefits are prevention or reduction of dye transfer from one fabric to another fabric or another part of the same fabric (an effect that is also termed dye transfer inhibition or anti-backstaining), removal of protruding or broken fibers from a fabric surface to decrease pilling tendencies or remove already existing pills or fuzz (an effect that also is termed anti-pilling), improvement of the fabric-softness, colour clarification of the fabric and removal of particulate soils which are trapped in the fibers of the fabric or garment. Enzymatic bleaching is a further enzyme detergency benefit where the catalytic activity generally is used to catalyze the formation of bleaching components such as hydrogen peroxide or other peroxides.

Fatty acid: A fatty acid is a carboxylic acid with an aliphatic tail (chain), which is either saturated or unsaturated. Most naturally occurring fatty acids have a chain of an even number of carbon atoms, from 4 to 28. Fatty acids are usually derived from triglycerides or phospholipids. When they are not attached to other molecules, they are known as “free” fatty acids. Examples of fatty acids include, but are not limited to, butanoic acid (butyric acid), pentanoic acid (valeric acid), hexanoic acid (caproic acid), heptanoic acid (enanthic acid), octanoic acid (caprylic acid), nonanoic acid (pelargonic acid), decanoic acid (capric acid), dodecanoic acid (lauric acid), tetradecanoic acid (myristic acid), hexadecanoic acid (palmitic acid), octadecanoic acid (stearic acid), eicosanoic acid (arachidic acid), linoleic acid, linolenic acid, arachidonic acid, eicosapentaenoic acid, and docosahexaenoic acid. It is to be understood that in the context of this invention, a fatty acid and an acyl group of a lipid are equivalents. When the fatty acid is an acyl group of a lipid, the lipid can be a monoglyceride, diglyceride, triglyceride, phospholipid or sphingolipid. The acyl group may be saturated or unsaturated, and optionally functional groups (substituents) may be attached. Examples of acyl groups include, but are not limited to, the acyl forms of butanoic acid (butyric acid), pentanoic acid (valeric acid), hexanoic acid (caproic acid), heptanoic acid (enanthic acid), octanoic acid (caprylic acid), nonanoic acid (pelargonic acid), decanoic acid (capric acid), dodecanoic acid (lauric acid), tetradecanoic acid (myristic acid), hexadecanoic acid (palmitic acid), octadecanoic acid (stearic acid), eicosanoic acid (arachidic acid), linoleic acid, linolenic acid, arachidonic acid, eicosapentaenoic acid, and docosahexaenoic acid.

Fragment: The term “fragment” means a polypeptide having one or more (e.g., several) amino acids absent from the amino and/or carboxyl terminus of a mature polypeptide or domain; wherein the fragment has lipoxygenase activity.

Fungal: In the context of the present invention the term “fungal” in relation to polypeptide (such as an enzyme, e.g. a lipoxygenase) refers to a polypeptide encoded by and thus directly derivable from the genome of a fungus, where such fungus has not been genetically modified to encode said polypeptide, e.g. by introducing the encoding sequence in the genome by recombinant DNA technology. In the context of the present invention, the term “fungal lipoxygenase” or “polypeptide having lipoxygenase activity obtained from a fungal source” thus refers to a lipoxygenase encoded by and thus directly derivable from the genome of a fungal species, where the fungal species has not been subjected to a genetic modification introducing recombinant DNA encoding said lipoxygenase. Thus, the nucleotide sequence encoding the fungal polypeptide having lipoxygenase activity is a sequence naturally in the genetic background of a fungal species. The fungal polypeptide having lipoxygenase activity encoding by such sequence may also be referred to a wildtype lipoxygenase (or parent lipoxygenase). In a further aspect, the invention provides polypeptides having lipoxygenase activity, wherein said polypeptides are substantially homologous to a fungal lipoxygenase. In the context of the present invention, the term “substantially homologous” denotes a polypeptide having lipoxygenase activity which is at least 80%, preferably at least 85%, more preferably at least 90%, more preferably at least 95%, even more preferably at least 96%, 97%, 98%, and most preferably at least 99% identical to the amino acid sequence of a selected fungal lipoxygenase. The polypeptides being substantially homologous to a fungal lipoxygenase may be included in the detergent of the present invention and/or be used in the methods of the present invention.

Host cell: The term “host cell” means any cell type that is susceptible to transformation, transfection, transduction, or the like with a nucleic acid construct or expression vector comprising a polynucleotide of the present invention. The term “host cell” encompasses any progeny of a parent cell that is not identical to the parent cell due to mutations that occur during replication.

Improved wash performance: The term “improved wash performance” is defined herein as an enzyme displaying an increased wash performance in a detergent composition relative to the wash performance of same detergent composition without the enzyme e.g. by increased stain removal or improved bleaching. The term “improved wash performance” includes wash performance in laundry.

Isolated: The term “isolated” means a substance in a form or environment that does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., recombinant production in a host cell; multiple copies of a gene encoding the substance; and use of a stronger promoter than the promoter naturally associated with the gene encoding the substance). An isolated substance may be present in a fermentation broth sample; e.g. a host cell may be genetically modified to express the polypeptide of the invention. The fermentation broth from that host cell will comprise the isolated polypeptide.

Launderinq: The term “laundering” relates to both household laundering and industrial laundering and means the process of treating textiles with a solution containing a detergent composition and optionally one or more enzymes. The laundering process can for example be carried out using e.g. a household or an industrial washing machine or can be carried out by hand.

Lipoxygenase: The lipoxygenase (EC 1.13.11.12, linoleate: oxidoreductase, LOX) is an enzyme that catalyzes the oxygenation of polyunsaturated fatty acids such as linoleic acid, linolenic acid and arachidonic acid, which contain a cis,cis-1,4-pentadiene unit and produces hydroperoxides of these fatty acids. The lipoxygenase of the invention is able to oxidize substrates containing a cis-cis-pentadienyl moiety. Thus, it may act on polyunsaturated fatty acids such as linoleic acid (18 carbon atoms, 2 double bonds), linolenic acid (18:3), arachidonic acid (20:4), eicosapentaenoic acid (EPA, 20:5) and/or docosahexaenoic acid (DHA, 22:6).

The lipoxygenase may be a 9-lipoxygenase with the ability to oxidize the double bond between carbon atoms 9 and 10 in linoleic acid and linolenic acid, or it may be a 13-lipoxygenase with the ability to oxidize the double bond between carbon atoms 12 and 13 in linoleic acid and linolenic acid, or it may be a 9/13-lipoxygenase with the ability to oxidize the double bond both between carbon atoms 9 and 10 and between carbon atoms 12 and 13.

The lipoxygenase may be from animal, plant or microbial source. A plant lipoxygenase may be from plants of the pulse family (Fabaceae), soybean (lipoxygenases 1, 2 and 3), cucumber, or barley. A microbial lipoxygenase may be from a yeast such as Saccharomyces cerevisiae, a thermophilic actinomycete such as Thermoactinomyces vulgaris or Thermomyces, e.g. T. lanuginosus, or from fungi.

A fungal lipoxygenase may be derived from Ascomycota, particularly Ascomycota incertae sedis e.g. Magnaporthaceae, such as Gaeumannomyces or Magnaporthe, or anamorphic Magnaporthaceae such as Pyricularia, or alternatively anamorphic Ascomycota such as Geotrichum, e.g. G. candidum. The fungal lipoxygenase may be from Gaeummanomyces graminis, e.g. G. graminis var. graminis, G. graminis var. avenae or G. graminis var. tritici, (WO 0220730) or Magnaporthe salvinii (WO 2002/086114). Also, a fungal lipoxygenase may be from Fusarium such as F. oxysporum or F. proliferatum, or Penicillium sp.

Malodor: The term “malodor” means an odor which is not desired on clean items. The cleaned item should smell fresh and clean without malodors adhered to the item. One example of malodor is compounds with an unpleasant smell, which may be produced by microorganisms. Another example is unpleasant smells can be sweat or body odor adhered to an item which has been in contact with human or animal. Another example of malodor can be the odor from spices, which sticks to items for example curry or other exotic spices which smells strongly.

Mature polypeptide: The term “mature polypeptide” means a polypeptide in its final form following translation and any post-translational modifications, such as N-terminal processing, C-terminal truncation, glycosylation, phosphorylation, etc.

Sequence identity: The relatedness between two amino acid sequences or between two nucleotide sequences is described by the parameter “sequence identity”. For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), pref-erably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EM-BOSS: The European Molecular Biology Open Software Suite, Rice et al., 2000, supra), prefer-ably version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment).

Textile: The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and toweling. The textile may be cellulose based such as natural cellulosics, includ-ing cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used it is intended to include the broader term textiles as well. In the context of the present invention, the term “textile” also covers fabrics. In the context of the present invention, the term “textile” is used interchangeably with fabric and cloth.

Used or worn: The term “used or worn” used herein about a textile means that textile that has been used or worn by a consumer or has been in touch with human skin e.g. during manufacturing or retailing. A consumer can be a person that buys the textile, e.g. a person buying a textile (e.g. new clothes or bedlinen) in a shop or a business that buys the textile (e.g. bed linen, tea towel or table cloth) for use in the business e.g. a hotel, a restaurant, a professional kitchen, an institution, a hospital or the like. In some situations, such used or worn textile bear the conventional stains which has not been thoroughly washed out and can form a gluing base for attracting and accumulating more airborne particulate matter.

Variant: The term “variant” means a polypeptide having same activity as the parent enzyme comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position. In the context of the present invention, a variant of an identified lipoxygenase has the enzymatic activity of the parent. In one embodiment, the lipoxygenase activity of the variant is increased with reference to the parent lipoxygenase, e.g. the mature polypeptide of SEQ ID NO: 1.

Wash cycle: The term “wash cycle” is defined herein as a washing operation wherein textiles are immersed in the wash liquor, mechanical action of some kind is applied to the textile in order to release stains and to facilitate flow of wash liquor in and out of the textile and finally the superfluous wash liquor is removed. After one or more wash cycles, the textile is generally rinsed and dried.

Wash liquor: The term “wash liquor” is defined herein as the solution or mixture of water and lipoxygenase. The wash liquor may include detergent components and optionally one or more enzymes in addition to the lipoxygenase.

Wash performance: The term “wash performance” is used as detergent composition's, enzyme's or polymer's capability to remove stains present on the object to be cleaned or maintain color and whiteness of textile during wash. The improvement in the wash performance may be quantified by calculating the so-called delta REM as described in Experimental section.

Weight percentage: is abbreviated w/w %, wt % or w %. The abbreviations are used interchangeably.

Whiteness: The term “Whiteness” is defined herein as a broad term with different meanings in different regions and for different consumers. Whiteness can be on white textiles or be used interchangely as brightness for colored textiles. Loss of whiteness or brightness can e.g. be due to greying, yellowing, or removal of optical brighteners/hueing agents. Greying and yellowing can be due to soil redeposition, stain redeposition, dirt/mud redeposition, pollution particles, body soils, colouring from e.g. iron and copper ions or dye transfer. Loss of whiteness might include one or several issues from the list below: colourant or dye effects; incomplete stain removal (e.g. body soils, sebum etc.); redeposition (greying, yellowing or other discolourations of the object) (removed soils reassociate with other parts of textile, soiled or unsoiled); chemical changes in textile during application; and clarification or brightening of colours.

### Sequence Overview

SEQ ID NO: 1 is a lipoxygenase from Glycine max

SEQ ID NO: 2 is a lipase from Thermomyces lanuginosus

### DETAILED DESCRIPTION OF THE INVENTION

The inventors of the present invention have surprisingly found that lipoxygenase has a very good performance on stain bleaching or removal in wash when the detergent is dosed at reduced detergent level. The invention makes it possible to use lipoxygenase for stain removal with good benefit and can at same time reduce the detergent load significantly. Accordingly, the present invention relates to the use of a lipoxygenase for bleaching or removing a stain on textile in a wash liquor, wherein the wash liquor comprises about 0-4 g/L of a detergent, such as 0-3.5 g/L of a detergent, and optionally one or more additional enzymes.

The wash liquor may have a temperature in the range of 5° C. to 95° C., or in the range of 10° C. to 80° C., in the range of 10° C. to 70° C., in the range of 10° C. to 60° C., in the range of 10° C. to 50° C., in the range of 15° C. to 40° C. or in the range of 20° C. to 40° C.

In one embodiment of the invention, the method for laundering an item further comprises draining of the wash liquor or part of the wash liquor after completion of a wash cycle. The wash liquor can then be re-used in a subsequent wash cycle or in a subsequent rinse cycle. The item may be exposed to the wash liquor during a first and optionally a second or a third wash cycle. In one embodiment the item is rinsed after being exposed to the wash liquor. The item can be rinsed with water or with water comprising a conditioner.

A lipoxygenase suitable for use as described in the present application is preferably a soybean lipoxygenase, such as the LOX-1 from soybean (Glycine max).

In an embodiment, the lipoxygenase comprises the amino acid sequence of SEQ ID NO: 1 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO 1. In one aspect, the polypeptides differ by up to 10 amino acids, e.g., 1, 2, 3, 4, 5, 6, 7, 8, 9, or 10, from the polypeptide comprising SEQ ID NO: 1.

In an embodiment, the lipoxygenase of SEQ ID NO: 1 comprises a substitution, deletion, and/or insertion at one or more (e.g., several) positions. In an embodiment, the number of amino acid substitutions, deletions and/or insertions introduced into the polypeptide SEQ ID NO: 1 is not more than 10, e.g., 1, 2, 3, 4, 5, 6, 7, 8 or 9. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding domain.

Examples of conservative substitutions are within the groups of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. Common substitutions are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/11e, Leu/Val, Ala/Glu, and Asp/Gly.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in a polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for enzyme activity to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labelling, in conjunction with mutation of putative contact site amino acids. See, for example, de Vos et al., 1992, Science 255: 306-312; Smith et al, 1992, J. Mol. Biol. 224: 899-904; Wlodaver et al., 1992, FEBS Lett. 309: 59-64. The identity of essential amino acids can also be inferred from an alignment with a related polypeptide.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochemistry 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

The polypeptide may be a hybrid polypeptide in which a region of one polypeptide is fused at the N-terminus or the C-terminus of a region of another polypeptide.

The polypeptide may be a fusion polypeptide or cleavable fusion polypeptide in which another polypeptide is fused at the N-terminus or the C-terminus of the polypeptide of the present invention. A fusion polypeptide is produced by fusing a polynucleotide encoding another polypeptide to a polynucleotide of the present invention. Techniques for producing fusion polypeptides are known in the art and include ligating the coding sequences encoding the polypeptides so that they are in frame and that expression of the fusion polypeptide is under control of the same promoter(s) and terminator. Fusion polypeptides may also be constructed using intein technology in which fusion polypeptides are created post-translationally (Cooper et al., 1993, EMBO J. 12: 2575-2583; Dawson et al., 1994, Science 266: 776-779).

A fusion polypeptide can further comprise a cleavage site between the two polypeptides. Upon secretion of the fusion protein, the site is cleaved releasing the two polypeptides. Examples of cleavage sites include, but are not limited to, the sites disclosed in Martin et al., 2003, J. Ind. Microbiol. Biotechnol. 3: 568-576; Svetina et al., 2000, J. Biotechnol. 76: 245-251; Rasmussen-Wilson et al., 1997, Appl. Environ. Microbiol. 63: 3488-3493; Ward et al., 1995, Biotechnology 13: 498-503; and Contreras et al., 1991, Biotechnology 9: 378-381; Eaton et al., 1986, Biochemistry 25: 505-512; Collins-Racie et al., 1995, Biotechnology 13: 982-987; Carter et al., 1989, Proteins: Structure, Function, and Genetics 6: 240-248; and Stevens, 2003, Drug Discovery World 4: 35-48.

General methods of PCR, cloning, ligation nucleotides etc. are well-known to a person skilled in the art and may for example be found in in “Molecular cloning: A laboratory manual”, Sambrook et al. (1989), Cold Spring Harbor lab., Cold Spring Harbor, NY; Ausubel, F. M. et al. (eds.); “Current protocols in Molecular Biology”, John Wiley and Sons, (1995); Harwood, C. R., and Cutting, S. M. (eds.); “DNA Cloning: A Practical Approach, Volumes I and II”, D. N. Glover ed. (1985); “Oligonucleotide Synthesis”, M. J. Gait ed. (1984); “Nucleic Acid Hybridization”, B. D. Hames & S. J. Higgins eds (1985); “A Practical Guide To Molecular Cloning”, B. Perbal, (1984).

The concentration of the lipoxygenase (as AEP) in the wash liquor is typically in the range of 0.05-20 ppm (mg/L) active enzyme protein, such as in the range of 0.1-15 ppm, in the range of 0.5-15 ppm, in the range of 1-15 ppm, in the range of 1-10 ppm, in the range of 2-10 ppm.

The lipoxygenase (as formulated product) may be present in the detergent in a concentration from 0.2-10 wt %, such as in the range of 0.5-5 wt %, such as in the range of 0.5-3 wt %, such as in the range of 0.5-2.5 wt %, or in the range of 0.5-2 wt %, or even in the range of 0.5-1 wt %.

The lipoxygenase of the detergent composition of the invention may be stabilized using conventional stabilizing agents, e.g. a polyol such as propylene glycol or glycerol, a sugar or sugar alcohol, lactic acid, boric acid, or a boric acid derivative, e.g. an aromatic borate ester, or a phenyl boronic acid derivative such as 4-formylphenyl boronic acid, and the composition may be formulated as described in, for example, WO92/19709 and WO92/19708.

A polypeptide of the present invention may also be incorporated in the detergent formulations disclosed in WO97/07202, which is hereby incorporated by reference.

### Liquid Enzyme Formulations

The enzymes (lipoxygenase, lipase and other enzymes present) may be formulated as a liquid enzyme formulation, which is generally a pourable composition, though it may also have a high viscosity. The physical appearance and properties of a liquid enzyme formulation may vary a lot—for example, they may have different viscosities (gel to water-like), be colored, not colored, clear, hazy, and even with solid particles like in slurries and suspensions. The minimum ingredients are the enzymes (lipoxygenase and optionally other enzymes present) and a solvent system to make it a liquid.

The solvent system may comprise water, polyols (such as glycerol, (mono, di, or tri) propylene glycol, (mono, di, or tri) ethylene glycol, sugar alcohol (e.g. sorbitol, mannitol, erythritol, dulcitol, inositol, xylitol or adonitol), polypropylene glycol, and/or polyethylene glycol), ethanol, sugars, and salts. Usually the solvent system also includes a preservation agent and/or other stabilizing agents.

A liquid enzyme formulation may be prepared by mixing a solvent system and an enzyme concentrate with a desired degree of purity (or enzyme particles to obtain a slurry/suspension).

In an embodiment, the liquid enzyme composition comprises:
(a) at least 0.01% w/w active enzyme protein,
(b) at least 0.5% w/w polyol,
(c) water, and
(d) optionally a preservation agent.

The enzymes (lipoxygenase and optionally other enzymes present) in the liquid composition of the invention may be stabilized using conventional stabilizing agents. Examples of stabilizing agents include, but are not limited to, sugars like glucose, fructose, sucrose, or trehalose; polyols like glycerol, propylene glycol; addition of salt to increase the ionic strength; divalent cations (e.g., Ca²⁺ or Mg²⁺); and enzyme inhibitors, enzyme substrates, or various polymers (e.g., PVP). Selecting the optimal pH for the formulation may be very important for enzyme stability. The optimal pH depends on the specific enzyme but is typically in the range of pH 4-9. In some cases, surfactants like nonionic surfactant (e.g., alcohol ethoxylates) can improve the physical stability of the enzyme formulations.

One embodiment of the invention relates to a composition comprising a lipoxygenase, wherein the composition further comprises:
(i) a polyol, preferably selected from glycerol, (mono, di, or tri) propylene glycol, (mono, di, or tri) ethylene glycol, polyethylene glycol, sugar alcohols, sorbitol, mannitol, erythritol, dulcitol, inositol, xylitol and adonitol;
(ii) optionally an additional enzyme, preferably selected from proteases, amylases, cellulases, lipases, DNases, and/or mannanases;
(iii) optionally a surfactant, preferably selected from anionic and nonionic surfactants,
(iv) optionally a salt, divalent cation, polymer, or enzyme inhibitor;
(v) optionally having a pH in the range of pH 4-9; and
(vi) water.

Slurries or dispersions of enzymes are typically prepared by dispersing small particles of enzymes (e.g., spray-dried particles) in a liquid medium in which the enzyme is sparingly soluble, e.g., a liquid nonionic surfactant or a liquid polyethylene glycol. Powder can also be added to aqueous systems in an amount so not all go into solution (above the solubility limit). Another format is crystal suspensions which can also be aqueous liquids (see for example WO2019/002356). Another way to prepare such dispersion is by preparing water-in-oil emulsions, where the enzyme is in the water phase, and evaporate the water from the droplets. Such slurries/suspension can be physically stabilized (to reduce or avoid sedimentation) by addition of rheology modifiers, such as fumed silica or xanthan gum, typically to get a shear thinning rheology.

### Granular Enzyme Formulations

The enzymes (lipoxygenase and optionally other enzymes present) may also be formulated as a solid/granular enzyme formulation. Non-dusting granulates may be produced, e.g. as disclosed in U.S. Pat. Nos. 4,106,991 and 4,661,452, and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591.

The lipoxygenase may be formulated as a granule for example as a co-granule that combines one or more enzymes or benefit agents (such as MnTACN or other bleaching components). Examples of such additional enzymes include lipases, xyloglucanases, perhydrolases, peroxidases, lipoxygenases, laccases, hemicellulases, proteases, care cellulases, cellulases, cellobiose dehydrogenases, xylanases, phospho lipases, esterases, cutinases, pectinases, mannanases, pectate lyases, keratinases, reductases, oxidases, phenoloxidases, ligninases, pullulanases, tannases, pentosanases, lichenases glucanases, arabinosidases, hyaluronidase, chondroitinase, amylases, DNAse, and mixtures thereof. Each enzyme will then be present in more granules securing a more uniform distribution of enzymes in the detergent. This also reduces the physical segregation of different enzymes due to different particle sizes. Methods for producing multi-enzyme co-granulate for the detergent industry are disclosed in the IP.com disclosure IPCOM000200739D.

An embodiment of the invention relates to an enzyme granule/particle comprising a lipoxygenase. The granule is composed of a core, and optionally one or more coatings (outer layers) surrounding the core. Typically, the granule/particle size, measured as equivalent spherical diameter (volume based average particle size), of the granule is 20-2000 μm, particularly 50-1500 μm, 100-1500 μm or 250-1200 μm.

The core may include additional materials such as fillers, fibre materials (cellulose or synthetic fibers), stabilizing agents, solubilising agents, suspension agents, viscosity regulating agents, light spheres, plasticizers, salts, lubricants and fragrances. The core may include binders, such as synthetic polymer, wax, fat, or carbohydrate. The core may comprise a salt of a multivalent cation, a reducing agent, an antioxidant, a peroxide decomposing catalyst and/or an acidic buffer component, typically as a homogenous blend. The core may consist of an inert particle with the enzyme absorbed into it, or applied onto the surface, e.g., by fluid bed coating. The core may have a diameter of 20-2000 μm, particularly 50-1500 μm, 100-1500 μm or 250-1200 μm. The core can be prepared by granulating a blend of the ingredients, e.g., by a method comprising granulation techniques such as crystallization, precipitation, pan-coating, fluid bed coating, fluid bed agglomeration, rotary atomization, extrusion, prilling, spheronization, size reduction methods, drum granulation, and/or high shear granulation. Methods for preparing the core can be found in Handbook of Powder Technology; Particle size enlargement by C. E. Capes; Volume 1; 1980; Elsevier. These methods are well-known in the art and have also been described in international patent application WO2015/028567, pages 3-5, which is incorporated by reference.

The core of the enzyme granule/particle may be surrounded by at least one coating, e.g., to improve the storage stability, to reduce dust formation during handling, or for coloring the granule. The optional coating(s) may include a salt coating, or other suitable coating materials, such as polyethylene glycol (PEG), methyl hydroxy-propyl cellulose (MHPC) and polyvinyl alcohol (PVA). Examples of enzyme granules with multiple coatings are shown in WO 93/07263 and WO 97/23606.

Such coatings are well-known in the art, and have earlier been described in, for example, WO00/01793, WO2001/025412, and WO2015/028567, which are incorporated by reference.

In one aspect, the present invention provides a granule, which comprises:
(a) a core comprising a lipoxygenase according to the invention; and
(b) optionally a (salt) coating consisting of one or more layer(s) surrounding the core.

Another aspect of the invention relates to a layered granule, comprising:
(a) a (non-enzymatic) core;
(b) a coating surrounding the core, wherein the coating comprises a lipoxygenase; and
(c) optionally a (salt) coating consisting of one or more layer(s) surrounding the enzyme containing coating.

### Encapsulated Enzyme Formulations

The enzymes (lipoxygenase and optionally other enzymes present) may also be formulated as an encapsulated enzyme formulation (an ‘encapsulate’). This is particularly useful for separating the enzyme from other ingredients when the enzyme is added into, for example, a (liquid) cleaning composition, such as the detergent compositions described below.

Physical separation can be used to solve incompatibility between the enzyme(s) and other components. Incompatibility can arise if the other components are either reactive against the enzyme, or if the other components are substrates of the enzyme. Other enzymes can be substrates of proteases.

The enzyme may be encapsulated in a matrix, preferably a water-soluble or water dispersible matrix (e.g., water-soluble polymer particles), for example as described in WO 2016/023685. An example of a water-soluble polymeric matrix is a matrix composition comprising polyvinyl alcohol. Such compositions are also used for encapsulating detergent compositions in unit-dose formats.

The enzyme may also be encapsulated in core-shell microcapsules, for example as described in WO 2015/144784, or as described in the IP.com disclosure IPCOM000239419D.

Such core-shell capsules can be prepared using a number of technologies known in the art, e.g., by interfacial polymerization using either a water-in-oil or an oil-in-water emulsion, where polymers are crosslinked at the surface of the droplets in the emulsion (the interface between water and oil), thus forming a wall/membrane around each droplet/capsule.

### Formulation of Enzyme in Co-Granule

The enzymes (lipoxygenase and optionally other enzymes present) may be formulated as a granule for example as a co-granule that combines one or more enzymes. Each enzyme will then be present in more granules securing a more uniform distribution of enzymes in the detergent. This also reduces the physical segregation of different enzymes due to different particle sizes. Methods for producing multi-enzyme co-granulates for the detergent industry are disclosed in the IP.com disclosure IPCOM000200739D.

Another example of formulation of enzymes by the use of co-granulates are disclosed in WO 2013/188331, which relates to a detergent composition comprising (a) a multi-enzyme co-granule; (b) less than 10 wt % zeolite (anhydrous basis); and (c) less than 10 wt % phosphate salt (anhydrous basis), wherein said enzyme co-granule comprises from 10 wt % to 98 wt % moisture sink component and the composition additionally comprises from 20 wt % to 80 wt % detergent moisture sink component. WO 2013/188331 also relates to a method of treating and/or cleaning a surface, preferably a fabric surface comprising the steps of (i) contacting said surface with the detergent composition as claimed and described herein in an aqueous wash liquor, (ii) rinsing and/or drying the surface.

The multi-enzyme co-granule may comprise a lipoxygenase and (a) one or more enzymes selected from the group consisting of lipases, xyloglucanases, perhydrolases, peroxidases, lipoxygenases, laccases and mixtures thereof; and (b) one or more enzymes selected from the group consisting of hemicellulases, proteases, care cellulases, cellulases, cellobiose dehydrogenases, xylanases, phospho lipases, esterases, cutinases, pectinases, mannanases, pectate lyases, keratinases, reductases, oxidases, phenoloxidases, ligninases, pullulanases, tannases, pentosanases, lichenases glucanases, arabinosidases, hyaluronidase, chondroitinase, amylases, DNAse, and mixtures thereof.

### Purity of Enzyme in Formulations

The enzymes (lipoxygenase and optionally other enzymes present) used in the above-mentioned enzyme formulations may be purified to any desired degree of purity. This includes high levels of purification, as achieved for example by using methods of crystallization—but also none or low levels of purification, as achieved for example by using crude fermentation broth, as described in WO 2001/025411, or in WO 2009/152176.

### Microorganisms

The enzyme formulations, as well as the detergent formulations described below, may comprise one or more microorganisms or microbes. Generally, any microorganism(s) may be used in the enzyme/detergent formulations in any suitable amount(s)/concentration(s). Microorganisms may be used as the only biologically active ingredient, but they may also be used in conjunction with one or more of the enzymes described above.

The purpose of adding the microorganism(s) may, for example, be to reduce malodor as described in WO 2012/112718. Other purposes could include in-situ production of desirable biological compounds, or inoculation/population of a locus with the microorganism(s) to competitively prevent other non-desirable microorganisms form populating the same locus (competitive exclusion).

The term “microorganism” generally means small organisms that are visible through a microscope. Microorganisms often exist as single cells or as colonies of cells. Some microorganisms may be multicellular. Microorganisms include prokaryotic (e.g., bacteria and archaea) and eukaryotic (e.g., some fungi, algae, protozoa) organisms. Examples of bacteria may be Gram-positive bacteria or Gram-negative bacteria. Example forms of bacteria include vegetative cells and endospores. Examples of fungi may be yeasts, molds and mushrooms. Example forms of fungi include hyphae and spores. Herein, viruses may be considered microorganisms.

Microorganisms may be recombinant or non-recombinant. In some examples, the microorganisms may produce various substances (e.g., enzymes) that are useful for inclusion in detergent compositions. Extracts from microorganisms or fractions from the extracts may be used in the detergents. Media in which microorganisms are cultivated or extracts or fractions from the media may also be used in detergents. In some examples, specific of the microorganisms, substances produced by the microorganisms, extracts, media, and fractions thereof, may be specifically excluded from the detergents. In some examples, the microorganisms, or substances produced by, or extracted from, the microorganisms, may activate, enhance, preserve, prolong, and the like, detergent activity or components contained with detergents.

Generally, microorganisms may be cultivated using methods known in the art. The microorganisms may then be processed or formulated in various ways. In some examples, the microorganisms may be desiccated (e.g., lyophilized). In some examples, the microorganisms may be encapsulated (e.g., spray drying). Many other treatments or formulations are possible. These treatments or preparations may facilitate retention of microorganism viability over time and/or in the presence of detergent components. In some examples, however, microorganisms in detergents may not be viable. The processed/formulated microorganisms may be added to detergents prior to, or at the time the detergents are used.

In one embodiment, the microorganism is a species of Bacillus, for example, at least one species of Bacillus selected from the group consisting of Bacillus subtilis, Bacillus amyloliquefaciens, Bacillus licheniformis, Bacillus atrophaeus, Bacillus pumilus, Bacillus megaterium, or a combination thereof. In a preferred embodiment, the aforementioned Bacillus species are on an endospore form, which significantly improves the storage stability.

### Detergent Compositions

In one embodiment, the invention is directed to detergent compositions comprising a lipoxygenase in combination with one or more additional cleaning composition components. In one embodiment, the detergent composition comprises a polypeptide having lipoxygenase activity with an amino acid sequence having at least 60% identity, such as 70%, 80%, 90%, 95%, 96%, 97%, 98%, 99% or even 100% identity to the amino acid sequence set forth in SEQ ID NO: 1. In one embodiment the detergent composition is in solid form. In another embodiment, the detergent composition is in a liquid or gel form. In another embodiment a bar form. In one embodiment the detergent may be wrapped in water soluble PVOH film. The choice of additional components is within the skill of the artisan and includes conventional ingredients, including the exemplary non-limiting components set forth below.

### Liquid Detergent Composition

The liquid detergent composition may comprise a microcapsule, and thus form part of any detergent composition in any form, such as liquid and powder detergents, and soap and detergent bars.

In one embodiment, the invention is directed to liquid detergent compositions comprising a microcapsule, as described above, in combination with one or more additional cleaning composition components.

The microcapsule, as described above, may be added to the liquid detergent composition in an amount corresponding to from 0.0001% to 5% (w/w) active enzyme protein (AEP); preferably from 0.001% to 5%, more preferably from 0.005% to 5%, more preferably from 0.005% to 4%, more preferably from 0.005% to 3%, more preferably from 0.005% to 2%, even more preferably from 0.01% to 2%, and most preferably from 0.01% to 1% (w/w) active enzyme protein.

The liquid detergent composition has a physical form, which is not solid (or gas). It may be a pourable liquid, a paste, a pourable gel or a non-pourable gel. It may be either isotropic or structured, preferably isotropic. It may be a formulation useful for washing in automatic washing machines or for hand washing. It may also be a personal care product, such as a shampoo, toothpaste, or a hand soap.

The liquid detergent composition may be aqueous, typically containing at least 20% by weight and up to 95% water, such as up to 70% water, up to 50% water, up to 40% water, up to 30% water, or up to 20% water. Other types of liquids, including without limitation, alkanols, amines, diols, ethers and polyols may be included in an aqueous liquid detergent. An aqueous liquid detergent may contain from 0-30% organic solvent. A liquid detergent may even be non-aqueous, wherein the water content is below 10%, preferably below 5%.

Detergent ingredients can be separated physically from each other by compartments in water dissolvable pouches. Thereby negative storage interaction between components can be avoided.

Different dissolution profiles of each of the compartments can also give rise to delayed dissolution of selected components in the wash solution.

The detergent composition may take the form of a unit dose product. A unit dose product is the packaging of a single dose in a non-reusable container. It is increasingly used in detergents for laundry. A detergent unit dose product is the packaging (e.g., in a pouch made from a water-soluble film) of the amount of detergent used for a single wash.

Pouches can be of any form, shape and material which is suitable for holding the composition, e.g., without allowing the release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water-soluble acrylate copolymers, methyl cellulose, carboxy methyl cellulose, sodium dextrin, ethyl cellulose, hydroxyethyl cellulose, hydroxypropyl methyl cellulose, maltodextrin, polymethacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be a blend composition comprising hydrolytically degradable and water-soluble polymer blends such as polyactide and polyvinyl alcohol (known under the Trade reference M8630 as sold by Chris Craft In. Prod. Of Gary, Ind., US) plus plasticizers like glycerol, ethylene glycerol, Propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids (see e.g., US 2009/0011970).

### Detergent Ingredients

The choice of detergent components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

Any detergent components known in the art for use in detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in detergents may be utilized. The choice of such ingredients is well within the skill of the artisan and includes conventional ingredients, including the exemplary non-limiting components set forth below.

### Surfactants

The cleaning composition may comprise one or more surfactants, which may be anionic and/or cationic and/or non-ionic and/or semi-polar and/or zwitterionic, or a mixture thereof. In a particular embodiment, the detergent composition includes a surfactant system (comprising more than one surfactant) e.g. a mixture of one or more nonionic surfactants and one or more anionic surfactants. In one embodiment the detergent comprises at least one anionic surfactant and at least one non-ionic surfactant, the weight ratio of anionic to nonionic surfactant may be from 20:1 to 1:20. In one embodiment the amount of anionic surfactant is higher than the amount of non-ionic surfactant e.g. the weight ratio of anionic to non-ionic surfactant may be from 10:1 to 1.1:1 or from 5:1 to 1.5:1. The amount of anionic to non-ionic surfactant may also be equal and the weight ratios 1:1. In one embodiment the amount of non-ionic surfactant is higher than the amount of anionic surfactant and the weight ratio may be 1:10 to 1:1.1. Preferably the weight ratio of anionic to non-ionic surfactant is from 10:1 to 1:10, such as from 5:1 to 1:5, or from 5:1 to 1:1.2. Preferably, the weight fraction of non-ionic surfactant to anionic surfactant is from 0 to 0.5 or 0 to 0.2 thus non-ionic surfactant can be present or absent if the weight fraction is 0, but if non-ionic surfactant is present, then the weight fraction of the nonionic surfactant is preferably at most 50% or at most 20% of the total weight of anionic surfactant and non-ionic surfactant. Light duty detergent usually comprises more nonionic than anionic surfactant and there the fraction of non-ionic surfactant to anionic surfactant is preferably from 0.5 to 0.9. The total weight of surfactant(s) is typically present at a level of from about 0.1% to about 60% by weight, such as about 1% to about 40%, or about 3% to about 20%, or about 3% to about 10%. The surfactant(s) is chosen based on the desired cleaning application, and may include any conventional surfactant(s) known in the art. When included therein the detergent will usually contain from about 1% to about 40% by weight of an anionic surfactant, such as from about 5% to about 30%, including from about 5% to about 15%, or from about 15% to about 20%, or from about 20% to about 25% of an anionic surfactant. Non-limiting examples of anionic surfactants include sulfates and sulfonates, typically available as sodium or potassium salts or salts of monoethanolamine (MEA, 2-aminoethan-1-ol) or triethanolamine (TEA, 2,2′,2″-nitrilotriethan-1-ol); in particular, linear alkylbenzenesulfonates (LAS), isomers of LAS such as branched alkylbenzenesulfonates (BABS) and phenylalkanesulfonates; olefin sulfonates, in particular alpha-olefinsulfonates (AOS); alkyl sulfates (AS), in particular fatty alcohol sulfates (FAS), i.e., primary alcohol sulfates (PAS) such as dodecyl sulfate (SLS); alcohol ethersulfates (AES or AEOS or FES, also known as alcohol ethoxysulfates or fatty alcohol ether sulfates); paraffin sulfonates (PS) including alkane-1-sulfonates and secondary alkanesulfonates (SAS); ester sulfonates, including sulfonated fatty acid glycerol esters and alpha-sulfo fatty acid methyl esters (alpha-SFMe or SES or MES); alkyl- or alkenylsuccinic acids such as dodecenyl/tetradecenyl succinic acid (DTSA); diesters and monoesters of sulfosuccinic acid; fatty acid derivatives of amino acids. Anionic surfactants may be added as acids, as salts or as ethanolamine derivatives.

When included therein the detergent will usually contain from about 0.1% to about 40% by weight of a cationic surfactant, for example from about 0.5% to about 30%, in particular from about 1% to about 20%, from about 3% to about 10%, such as from about 3% to about 5%, from about 8% to about 12% or from about 10% to about 12%. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

When included therein the detergent will usually contain from about 0.2% to about 40% by weight of a nonionic surfactant, for example from about 0.5% to about 30%, in particular from about 1% to about 20%, from about 3% to about 10%, such as from about 3% to about 5%, from about 8% to about 12%, or from about 10% to about 12%. Non-limiting examples of nonionic surfactants include alcohol ethoxylates (AE or AEO) e.g. the AEO-series such as AEO-7, alcohol propoxylates, in particular propoxylated fatty alcohols (PFA), ethoxylated and propoxylated alcohols, alkoxylated fatty acid alkyl esters, such as ethoxylated and/or propoxylated fatty acid alkyl esters (in particular methyl ester ethoxylates, MEE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

When included therein the detergent will usually contain from about 0.01 to about 10% by weight of a semipolar surfactant. Non-limiting examples of semipolar surfactants include amine oxides (AO) such as alkyldimethylamine oxides, in particular N-(coco alkyl)-N,N-dimethylamine oxide and N-(tallow-alkyl)-N,N-bis(2-hydroxyethyl)amine oxide, and combinations thereof.

When included therein the detergent will usually contain from about 0.01% to about 10% by weight of a zwitterionic surfactant. Non-limiting examples of zwitterionic surfactants include betaines such as alkyldimethylbetaines, sulfobetaines, and combinations thereof.

Additional bio-based surfactants may be used e.g. wherein the surfactant is a sugar-based non-ionic surfactant which may be a hexyl-β-D-maltopyranoside, thiomaltopyranoside or a cyclic-maltopyranoside, such as described in EP2516606 B1. Other biosurfactants may include rhamnolipids and sophorolipids.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however, the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-10% by weight, for example 0-5% by weight, such as about 0.5 to about 5%, or about 3% to about 5%, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65% by weight, such as about 5% to about 50% of a detergent builder or co-builder, or a mixture thereof. The builder and/or co-builder may particularly be a chelating agent that forms water-soluble complexes with Ca and Mg. Any builder and/or co-builder known in the art for use in cleaning detergents may be utilized.

Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Clariant), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof.

The detergent composition may also contain from about 0-50% by weight, such as about 5% to about 30%, of a detergent co-builder. The detergent composition may include a co-builder alone, or in combination with a builder, for example a zeolite builder. Non-limiting examples of co-builders include or copolymers thereof, such as poly(acrylic acid) (PAA) or copoly(acrylic acid/maleic acid) (PAA/PMA). According to the present invention, these components can be included in lower levels than in currently available detergent compositions. Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diylbis(phosphonic acid (HEDP), ethylenediaminetetramethylenetetrakis(phosphonic acid) (EDTMPA), diethylenetriaminepentamethylenepentakis(phosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), aminotrimethylenetris(phosphonic acid) (ATMP), and combinations and salts thereof. Further exemplary builders and/or co-builders are described in, e.g., WO 09/102854 and U.S. Pat. No. 5,977,053.

### Polymers and Dispersants

Generally, detergent compositions may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide anti-redeposition, fiber protection, soil release, dye transfer inhibition, grease cleaning and/or anti-foaming properties. Some polymers may have more than one of the above-mentioned properties and/or more than one of the below-mentioned motifs. Exemplary polymers include poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include polyethylene oxide and polypropylene oxide (PEO-PPO), diquaternium ethoxy sulfate, styrene/acrylic copolymer and perfume capsules Other exemplary polymers are disclosed in, e.g., WO 2006/130575. Salts of the above-mentioned polymers are also contemplated.

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

According to the present invention, however, certain of the above polymers, namely, a polyacrylic acid, a modified polyacrylic acid polymer, a modified polyacrylic acid copolymer, a maleic acid-acrylic acid copolymer, carboxymethyl cellulose, cellulose gum, methyl cellulose, and/or combinations thereof, can be included in lower levels than in currently available detergent compositions, or even more preferably, excluded altogether.

### Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and EP1876226 (hereby incorporated by reference). The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO2007/087243.

### Dye Transfer Inhibiting Agents

The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

### Fluorescent Whitening Agent

The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino) stilbene-2,2′-disulfonate, 4,4′-bis-(2,4-dianilino-s-triazin-6-ylamino) stilbene-2.2′-disulfonate, 4,4′-bis-(2-anilino-4-(N-methyl-N-2-hydroxy-ethylamino)-s-triazin-6-ylamino) stilbene-2,2′-disulfonate, 4,4′-bis-(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino) stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Tinopal CBS-X is a 4.4′-bis-(sulfostyryl)-biphenyl disodium salt also known as Disodium Distyrylbiphenyl Disulfonate. Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

### Soil Release Polymers

The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore, random graft co-polymers are suitable soil release polymers. Suitable graft co-polymers are described in more detail in WO 2007/138054, WO 2006/108856 and WO 2006/113314 (hereby incorporated by reference).

### Anti-Redeposition Agents

The detergent compositions of the present invention may also include one or more anti-redeposition agents such as carboxymethylcellulose (CMC), polyvinyl alcohol (PVA), polyoxyethylene and/or polyethyleneglycol (PEG), homopolymers of acrylic acid, copolymers of acrylic acid and maleic acid. The cellulose based polymers described under soil release polymers above may also function as anti-redeposition agents.

### Rheology Modifiers

The detergent compositions of the present invention may also include one or more rheology modifiers, structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Additional Enzymes

The detergent additive as well as the detergent composition may comprise one or more [additional] enzymes such as a protease, a lipase, a cutinase, a cellulase, an amylase, carbohydrase, DNase, pectinase, mannanase, arabinase, galactanase, xylanase, oxidase, e.g., a laccase, and/or peroxidase.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

### Cellulases

The term “cellulase” means one or more (e.g., several) enzymes that hydrolyze a cellulosic material. The two terms polypeptide having cellulase activity and cellulase are used interchangeably. Cellulases may be selected from the group consisting of cellulases belonging to GH5, GH44, GH45, EC 3.2.1.4, EC 3.2.1.21, EC 3.2.1.91 and EC 3.2.1.172. Such enzymes include endoglucanase(s) (e.g. EC 3.2.1.4), cellobiohydrolase(s), beta-glucosidase(s), or combinations thereof.

Suitable cellulases include mono-component and mixtures of enzymes of bacterial or fungal origin. Chemically modified or protein engineered mutants are also contemplated. The cellulase may for example be a mono-component or a mixture of mono-component endo-1,4-beta-glucanase also referred to as endoglucanase.

### DNases (Deoxyribonuclease)

The term “DNase” means a polypeptide with DNase activity that catalyzes the hydrolytic cleavage of phosphodiester linkages in the DNA backbone, thus degrading DNA.

### Mannanases

Suitable mannanases include those of bacterial or fungal origin. Chemically or genetically modified mutants are included. The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619. A commercially available mannanase is Mannaway (Novozymes A/S).

### Proteases

Suitable proteases may be of any origin, but are preferably of bacterial or fungal origin, optionally in the form of protein engineered or chemically modified mutants. The protease may be an alkaline protease, such as a serine protease or a metalloprotease. A serine protease may for example be of the S1 family, such as trypsin, or the S8 family such as a subtilisin. A metalloprotease may for example be a thermolysin, e.g. from the M4 family, or another metalloprotease such as those from the M5, M7 or M8 families.

The term “subtilases” refers to a sub-group of serine proteases according to Siezen et al., Protein Eng. 4 (1991) 719-737 and Siezen et al., Protein Sci. 6 (1997) 501-523. Serine proteases are a subgroup of proteases characterized by having a serine in the active site, which forms a covalent adduct with the substrate. The subtilases may be divided into six subdivisions, the Subtilisin family, the Thermitase family, the Proteinase K family, the Lantibiotic peptidase family, the Kexin family and the Pyrolysin family.

Although proteases suitable for detergent use may be obtained from a variety of organisms, including fungi such as Aspergillus, detergent proteases have generally been obtained from bacteria and in particular from Bacillus. Examples of Bacillus species from which subtilases have been derived include Bacillus lentus, Bacillus alkalophilus, Bacillus subtilis, Bacillus amyloliquefaciens, Bacillus licheniformis, Bacillus pumilus and Bacillus gibsonii. Particular subtilisins include subtilisin lentus, subtilisin Novo, subtilisin Carlsberg, subtilisin BPN′, subtilisin 309, subtilisin 147 and subtilisin 168 and e.g. protease PD138 (described in WO 93/18140). Other useful proteases are e.g. those described in WO 01/16285 and WO 02/16547.

Examples of trypsin-like proteases include the Fusarium protease described in WO 94/25583 and WO 2005/040372, and the chymotrypsin proteases derived from Cellumonas described in WO 2005/052161 and WO 2005/052146.

Examples of metalloproteases include the neutral metalloproteases described in WO 2007/044993 such as those derived from Bacillus amyloliquefaciens, as well as e.g. the metalloproteases described in WO 2015/158723 and WO 2016/075078.

Examples of useful proteases are the protease variants described in WO 89/06279 WO 92/19729, WO 96/34946, WO 98/20115, WO 98/20116, WO 99/11768, WO 01/44452, WO 03/006602, WO 2004/003186, WO 2004/041979, WO 2007/006305, WO 2011/036263, WO 2014/207227, WO 2016/087617 and WO 2016/174234.

Suitable commercially available protease enzymes include those sold under the trade names Alcalase®, Duralase™, Durazym™, Relase®, Relase® Ultra, Savinase®, Savinase® Ultra, Primase™, Polarzyme®, Kannase®, Liquanase®, Liquanase® Ultra, Ovozyme®, Coronase®, Coronase® Ultra, Blaze@, Blaze Evity® 100T, Blaze Evity® 125T, Blaze Evity® 150T, Blaze Evity® 200T, Neutrase®, Everlase®, Esperase®, Progress® Uno, Progress@ In and Progress@ Excel (Novozymes A/S), those sold under the tradename Maxatase™, Maxacal™, Maxapem®, Purafect® Ox, Purafect® OxP, Puramax®, FN2™, FN3™, FN4ex™, Excellase®, Excellenz™ P1000, Excellenz™ P1250, Eraser™, Preferenz® P100, Purafect Prime, Preferenz P110™, Effectenz P1000™, Purafect®, Effectenz P1050™, Purafect® Ox, Effectenz™ P2000, Purafast™, Properase®, Opticlean™ and Optimase® (Danisco/DuPont), BLAP (sequence shown in FIG. 29 of U.S. Pat. No. 5,352,604) and variants hereof (Henkel AG), and KAP (Bacillus alkalophilus subtilisin) from Kao.

### Lipases and Cutinases

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include include Lipolase 100T/L, Lipex 100T/L, Lipex 105T, Lipex Evity 100L, Lipex Evity 200L (all Novozymes A/S), Preferenz® L 100 (DuPont).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

### Amylases

Suitable amylases include an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof.

Other examples are amylase variants such as those described in WO2011/098531, WO2013/001078 and WO2013/001087.

Commercially available amylases are Duramyl™, Termamyl™, Fungamyl™, Stainzyme™ Stainzyme PIus™, Natalase™, Liquozyme X and BAN™ Amplify; Amplify Prime; (from Novozymes A/S), and Rapidase™, Purastar™/Effectenz™, Powerase, Preferenz S1000, Preferenz S100 and Preferenz S110 (from Genencor International Inc./DuPont).

### Peroxidases/Oxidases

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257. Commercially available peroxidases include Guardzyme™ (Novozymes A/S).

A suitable peroxidase is preferably a peroxidase enzyme comprised by the enzyme classification EC 1.11.1.7, as set out by the Nomenclature Committee of the International Union of Biochemistry and Molecular Biology (IUBMB), or any fragment derived therefrom, exhibiting peroxidase activity.

Suitable peroxidases also include a haloperoxidase enzyme, such as chloroperoxidase, bromoperoxidase and compounds exhibiting chloroperoxidase or bromoperoxidase activity. Haloperoxidases are classified according to their specificity for halide ions. Chloroperoxidases (E.C. 1.11.1.10) catalyze formation of hypochlorite from chloride ions. The haloperoxidase may be a chloroperoxidase. Preferably, the haloperoxidase is a vanadium haloperoxidase, i.e., a vanadate-containing haloperoxidase. In a preferred method the vanadate-containing haloperoxidase is combined with a source of chloride ion.

Haloperoxidases have been isolated from many different fungi, in particular from the fungus group dematiaceous hyphomycetes, such as Caldariomyces, e.g., C. fumago, Alternaria, Curvularia, e.g., C. verruculosa and C. inaequalis, Drechslera, Ulocladium and Botrytis.

Haloperoxidases have also been isolated from bacteria such as Pseudomonas, e.g., P. pyrrocinia and Streptomyces, e.g., S. aureofaciens.

The haloperoxidase may be derivable from Curvularia sp., in particular Curvularia verruculosa or Curvularia inaequalis, such as C. inaequalis CBS 102.42 as described in WO 95/27046; or C. verruculosa CBS 147.63 or C. verruculosa CBS 444.70 as described in WO 97/04102; or from Drechslera hartlebii as described in WO 01/79459, Dendryphiella salina as described in WO 01/79458, Phaeotrichoconis crotalarie as described in WO 01/79461, or Geniculosporium sp. as described in WO 01/79460.

Suitable oxidases include, in particular, any laccase enzyme comprised by the enzyme classification EC 1.10.3.2, or any fragment derived therefrom exhibiting laccase activity, or a compound exhibiting a similar activity, such as a catechol oxidase (EC 1.10.3.1), an o-aminophenol oxidase (EC 1.10.3.4), or a bilirubin oxidase (EC 1.3.3.5).

Preferred laccase enzymes are enzymes of microbial origin. The enzymes may be derived from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinopsis, e.g., C. cinerea, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radiata (WO 92/01046), or Coriolus, e.g., C. hirsutus (JP 2238885).

Suitable examples from bacteria include a laccase derivable from a strain of Bacillus.

A laccase derived from Coprinopsis or Myceliophthora is preferred; in particular a laccase derived from Coprinopsis cinerea, as disclosed in WO 97/08325; or from Myceliophthora thermophila, as disclosed in WO 95/33836.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may be non-aqueous.

### Laundry Soap Bars

The lipoxygenase of the invention may be added to laundry soap bars and used for hand washing laundry, fabrics and/or textiles. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na+, K or NH₄+ and the organic anion may be for example formate, acetate, citrate or lactate such that the salt of a monovalent cation and an organic anion may be, for example, sodium formate.

The laundry soap bar may also contain complexing agents like EDTA and HEDP, perfumes and/or different type of fillers, surfactants e.g. anionic synthetic surfactants, builders, polymeric soil release agents, detergent chelators, stabilizing agents, fillers, dyes, colorants, dye transfer inhibitors, alkoxylated polycarbonates, suds suppressers, structurants, binders, leaching agents, bleaching activators, clay soil removal agents, anti-redeposition agents, polymeric dispersing agents, brighteners, fabric softeners, perfumes and/or other compounds known in the art.

The laundry soap bar may be processed in conventional laundry soap bar making equipment such as, but not limited to, mixers, plodders, e.g. a two-stage vacuum plodder, extruders, cutters, logo-stampers, cooling tunnels and wrappers. The invention is not limited to preparing the laundry soap bars by any single method. The premix of the invention may be added to the soap at different stages of the process. For example, the premix containing a soap, lipoxygenase, optionally one or more additional enzymes, a protease inhibitor, and a salt of a monovalent cation and an organic anion may be prepared, and the mixture is then plodded. The lipoxygenase and optional additional enzymes may be added at the same time as the protease inhibitor for example in liquid form. Besides the mixing step and the plodding step, the process may further comprise the steps of milling, extruding, cutting, stamping, cooling and/or wrapping.

### EMBODIMENTS OF THE INVENTION

The invention is further summarized in the following embodiments. The embodiments are indicated as E1, E2 and so forth.
E1. Use of a polypeptide having lipoxygenase activity for bleaching or removing a stain on textile in a wash liquor, wherein the wash liquor comprises from about 0 g detergent/L wash liquor to about 4 g detergent/L wash liquor, optionally one or more polyunsaturated fatty acids, such as linoleic acid, and optionally one or more additional enzymes.
E2. The use according to embodiment 1, wherein the wash liquor comprises about 0.1-3.5 g detergent/L wash liquor, such as about 0.1-3.0 g detergent/L wash liquor, such as about 0.1-2.5 g detergent/L wash liquor, such as about 0.1-2.0 g detergent/L wash liquor, such as about 0.1-1.5 g detergent/L wash liquor, such as about 0.2-1.5 g detergent/L wash liquor, such as about 0.2-2.0 g detergent/L wash liquor, such as about 0.2-2.5 g detergent/L wash liquor, such as about 0.2-3.0 g detergent/L wash liquor, such as about 0.1-3.5 g detergent/L wash liquor.
E3. The use according to any of embodiments 1-2, wherein the polypeptide having lipoxygenase activity is a soybean lipoxygenase.
E4. The use according to any of embodiments 1-3, wherein the polypeptide having lipoxygenase activity is soybean lipoxygenase 1 (LOX-1)
E5. The use according to any of embodiments 1-4, wherein the lipoxygenase has at least 60% sequence identity, e.g., at least 65% sequence identity, at least 70% sequence identity, at least 75% sequence identity, at least 80% sequence identity, at least 85% sequence identity, at least 90% sequence identity, at least 91% sequence identity, at least 92% sequence identity, at least 93% sequence identity, at least 94% sequence identity, at least 95% sequence identity, at least 96% sequence identity, at least 97% sequence identity, at least 98% sequence identity, at least 99% sequence identity, or even 100% sequence identity to the polypeptide of SEQ ID NO: 1.
E6. The use according to any of embodiments 1-5, wherein the polypeptide having lipoxygenase activity is used in combination with at least one additional enzyme, wherein the at least one additional enzyme is selected from the group consisting of protease, amylase, deoxyribonuclease, lipase, xyloglucanase, cutinase, pectinase, pectin lyase, xanthanases, peroxidase, haloperoxygenases, catalase and mannanase.
E7. The use according to embodiment 6, wherein the polypeptide having lipoxygenase activity is used in combination with a lipase.
E8. The use according to any of embodiments 6 and 7, wherein the lipase has at least 60% sequence identity, e.g., at least 65% sequence identity, at least 70% sequence identity, at least 75% sequence identity, at least 80% sequence identity, at least 85% sequence identity, at least 90% sequence identity, at least 91% sequence identity, at least 92% sequence identity, at least 93% sequence identity, at least 94% sequence identity, at least 95% sequence identity, at least 96% sequence identity, at least 97% sequence identity, at least 98% sequence identity, at least 99% sequence identity, or even 100% sequence identity to the polypeptide of SEQ ID NO: 2.
E9. A detergent composition comprising a lipoxygenase, and a biosurfactant selected from the group consisting of rhamnolipid and sophorolipid, optionally one or more polyunsaturated fatty acids and optionally at least one additional enzyme.
E10. The detergent composition according to embodiment 9, wherein the lipoxygenase has at least 60% sequence identity, e.g., at least 65% sequence identity, at least 70% sequence identity, at least 75% sequence identity, at least 80% sequence identity, at least 85% sequence identity, at least 90% sequence identity, at least 91% sequence identity, at least 92% sequence identity, at least 93% sequence identity, at least 94% sequence identity, at least 95% sequence identity, at least 96% sequence identity, at least 97% sequence identity, at least 98% sequence identity, at least 99% sequence identity, or even 100% sequence identity to the polypeptide of SEQ ID NO:1.
E11. The detergent composition according to any of embodiments 9 and 10, wherein the at least one additional enzyme is selected from the group consisting of proteases, amylases, deoxyribonucleases, lipases, xyloglucanases, cutinases, pectinases, pectin lyases, xanthanases, peroxidases, haloperoxygenases, catalases and mannanases.
E12. The detergent composition according to any of embodiments 9 to 11, wherein the detergent composition comprises a lipase.
E13. The detergent composition according to, wherein the lipase has at least 60% sequence identity, e.g., at least 65% sequence identity, at least 70% sequence identity, at least 75% sequence identity, at least 80% sequence identity, at least 85% sequence identity, at least 90% sequence identity, at least 91% sequence identity, at least 92% sequence identity, at least 93% sequence identity, at least 94% sequence identity, at least 95% sequence identity, at least 96% sequence identity, at least 97% sequence identity, at least 98% sequence identity, at least 99% sequence identity, or even 100% sequence identity to the polypeptide of SEQ ID NO: 2.
E14. Use of the detergent composition of any of embodiments 9 to 13 for bleaching or removing a stain from a surface by contacting the stain with a lipoxygenase in a wash liquour, wherein the wash liquor comprises from about 0.1 g detergent/L wash liquor to about 4 g detergent/L wash liquor, optionally one or more polyunsaturated fatty acids, such as linoleic acid, and optionally one or more additional enzymes.
E 15. The use according to embodiment 14, wherein the wash liquor comprises about 0.1-3.5 g detergent/L wash liquor, such as about 0.1-3.0 g detergent/L wash liquor, such as about 0.1-2.5 g detergent/L wash liquor, such as about 0.1-2.0 g detergent/L wash liquor, such as about 0.1-1.5 g detergent/L wash liquor, such as about 0.2-1.5 g detergent/L wash liquor, such as about 0.2-2.0 g detergent/L wash liquor, such as about 0.2-2.5 g detergent/L wash liquor, such as about 0.2-3.0 g detergent/L wash liquor, such as about 0.1-3.5 g detergent/L wash liquor.
E16. A method for laundering an item, which method comprises the steps of:
   a) exposing an item to a wash liquor comprising a lipoxygenase, from about 0 g detergent/L wash liquor to about 4 g detergent/L wash liquor, optionally one or more polyunsaturated fatty acids and optionally at least one additional enzyme,
   b) completing at least one wash cycle;
   c) optionally rinsing the item.
E17. The use according to any of embodiments 1 and 9, the detergent composition according to embodiment 9 or the method according to embodiment 16, wherein the polyunsaturated fatty acid is a free fatty acid or an acyl group of a lipid, wherein the lipid can be a monoglyceride, diglyceride, triglyceride, phospholipid or sphingolipid.
E18. In a preferred embodiment of embodiment 17 the free fatty acid or the acyl group is linoleic acid.

### Detergent Compositions

The below mentioned ranges of detergent components are generally useful for laundering.

TABLE 1
Liquid detergent composition

| Ingredient | Amount (in wt %) |
|---|---|
| Anionic detersive surfactant (such as alkyl benzene sulphonate, | from 0 wt % to 40 wt % |
| alkyl ether sulphate, alpha-olefin sulphonate, methyl ester | thereof) |
| sulphonate and mixtures) | |
| Non-ionic detersive surfactant (such as alkyl ethoxylated alcohol, | from 0 wt % to 40 wt % |
| alkylpoly glucosides; Glycereth-6 Laurate, biosurfactants, and | |
| mixtures) | |
| Other detersive surfactant (such as zwitterionic detersive surfactants, | from 0 wt % to 4 wt % |
| amphoteric surfactants, quaternary ammonium compounds and | |
| mixtures thereof) | |
| Carboxylate polymer (such as co-polymers of maleic acid and acrylic | from 0 wt % to 4 wt % |
| acid, add other PCA polymers, eg. Sokalan CP types, Acusol types, etc) | |
| Polyethylene glycol polymer (such as a polyethylene glycol polymer | from 0 wt % to 4 wt % |
| comprising poly vinyl acetate side chains, PEG/vinyl acetate | |
| co-polymer, e.g Sokalan HP22 type) | |
| Polyester or terephthalate soil release polymer (such as | From 0 to 4 wt % |
| Polypropylene/Polyethylene Terephthalate; Polyethylene Terephthalate; | |
| Sulfonated Polyethylene/Polyethylene Terephthalate anionic polyester, | |
| nonionic polymer, examples are the REPEL-O-TEX ® line of polymers | |
| (Solvay), including REPEL-O-TEX ® Crystal, REPEL-O-TEX ® SRP-6 | |
| and REPEL-O-TEX ® SF-2, Marloquest ® polymers, such as | |
| Marloquest ® SL (Sasol), and/or TexCare ® polymers, including | |
| TexCare ® SRA-300, TexCare ®, TexCare ® SRN-170, TexCare ® | |
| SRN-240, TexCare ® SRN-260, and TexCare ® SRN-325, (Clariant). | |
| Other polymer (such as amine polymers, dye PVP-NO/Polyvinyl | from 0 wt % to 10 wt % |
| Pyrrolidone N-oxide; Vinylpyrrolidone/vinylimidazole co-polymers, | |
| hexamethylenediamine derivative polymers, Ethoxylated | |
| polyethylene-polyamine; AZIRIDIN, HOMOPOLYMER, and | |
| mixtures thereof, eg. Sokalan HP types, Sokalan K types | |
| Other builder (such as sodium citrate and/or citric acid, ethanolamine | from 0 wt % to 10 wt % |
| (such as MEA, DEA and TEA) | |
| Carbonate salt (such as sodium carbonate and/or sodium bicarbonate) | from 0 wt % to 10 wt % |
| Solvents (such as, 1,2-propanediol, glycerol and ethanol) | 0 wt % to 40 wt % |
| Chelant (such as the phosphonates and aminocarboxylates | from 0 wt % to2 wt % |
| (ethylenediamine-N′N′-disuccinic acid (EDDS) and/or hydroxyethane | |
| diphosphonic acid (HEDP), diethylenetriamine penta(methylene | |
| phosphonic acid) (DTPMP), Diethylenetriamine-pentaacetic acid | |
| (DTPA), Ethylenediaminetetraacetic acid (EDTA) , methylglycine | |
| diacetic acid (MGDA); glutamic acid-N,N-diacetic acid (GLDA)) | |
| Optical brightener (such as 4,4′-Distyryl biphenyl types, FWA 5; | from 0 wt % to 0.5 wt % |
| FWA 7; FWA 11 and the likes | |
| Formulated protease/s | from 0 wt % to 5 wt % |
| Formulated Amylase/s | from 0 wt % to 1 wt % |
| Formulated Lipoxygenase/s | from 0 wt % to 1 wt % |
| Formulated Lipase/s | from 0 to 1 wt % |
| Other formulated enzyme (such as xyloglucanase, cutinase, pectate | from 0 wt % to 2 wt % |
| lyase, mannanase, bleaching enzyme) | |
| Formulated DNase/s | 0.000001-10% |
| Fabric softener (such as montmorillonite clay and/or | from 0 wt % to 4 wt % |
| polydimethylsiloxane (PDMS) | |
| Suds suppressor (such as silicone and/or fatty acid) | from 0 wt % to 10 wt % |
| Perfume (such as perfume microcapsule, perfume extract, liquid | from 0 wt % to 1 wt % |
| perfume, and any combination thereof) | |
| Aesthetics (such as opacifiers and colorants) | from 0 wt % to 1 wt % |
| Preservatives (eg isothiazolinones, phenoxyethanol, etc) | From 0 wt % to 2 wt % |
| others | optional |
| Filler (such as water) | balance |

TABLE 2
Unit Dose composition

| Ingredient | Amount (in wt %) |
|---|---|
| Anionic detersive surfactant (such as alkyl benzene sulphonate, alkyl | from 0 wt % to 50 wt % |
| ether sulphate, alpha-olefin sulphonate, methyl ester sulphonate and | thereof |
| mixtures, as acids, neutralized salts or as monoethanolamine adducts) | |
| Non-ionic detersive surfactant (such as alkyl ethoxylated alcohol, | from 0 wt % to 50 wt % |
| alkylpoly glucosides; Glycereth-6 Laurate, biosurfactants and mixtures) | |
| Other detersive surfactant (such as zwitterionic detersive surfactants, | from 0 wt % to 5 wt % |
| amphoteric surfactants, quaternary ammonium compounds and | |
| mixtures thereof) | |
| Carboxylate polymer (such as co-polymers of maleic acid and acrylic | from 0 wt % to 5 wt % |
| acid, add other PCA polymers, eg. Sokalan CP types, Acusol types, etc) | |
| Polyethylene glycol polymer (such as a polyethylene glycol polymer | from 0 wt % to 5 wt % |
| comprising poly vinyl acetate side chains, PEG/vinyl acetate co-polymer | |
| Eg Sokalan HP22 type) | |
| Polyester or terephthalate soil release polymer (such as | From 0 to 5 wt % |
| Polypropylene/Polyethylene Terephthalate; Polyethylene | |
| Terephthalate; Sulfonated Polyethylene/Polyethylene Terephthalate | |
| anionic polyester, nonionic polymer, examples are the REPEL-O-TEX ® | |
| line of polymers (Solvay), including REPEL-O-TEX ® Crystal, | |
| REPEL-O-TEX ® SRP-6 and REPEL-O-TEX ® SF-2, Marloquest ® | |
| polymers, such as Marloquest ® SL (Sasol), and/or TexCare ® polymers, | |
| including TexCare ® SRA-300, TexCare ®, TexCare ® SRN-170, | |
| TexCare ® SRN-240, and TexCare ® SRN-325, (Clariant). | |
| Other polymer (such as amine polymers, dye transfer inhibitor polymers, | from 0 wt % to 20 wt % |
| PVP-NO/Polyvinyl Pyrrolidone N-oxide; Vinylpyrrolidone/ | |
| vinylimidazole co-polymers, hexamethylenediamine derivative polymers, | |
| Ethoxylated polyethylene-polyamine; AZIRIDIN, HOMOPOLYMER, | |
| and mixtures thereof, eg. Sokalan HP types, Sokalan K types | |
| Other builder (such as sodium citrate and/or citric acid, ethanolamine | from 0 wt % to 15 wt % |
| (such as MEA, DEA and TEA) | |
| Solvents (such as, 1,2-propanediol, 1,3-propanediol, glycerol, | 10 wt % to 60 wt % |
| dipropylene glycol, methylpropanediol, sorbitol and ethanol) | |
| Chelant (such as the phosphonates and aminocarboxylates | from 0 wt % to 4 wt % |
| (ethylenediamine-N′N′-disuccinic acid (EDDS) and/or hydroxyethane | |
| diphosphonic acid(HEDP), diethylenetriamine penta(methylene | |
| phosphonic acid) (DTPMP), Diethylenetriamine-pentaacetic acid | |
| (DTPA), Ethylenediaminetetraacetic acid (EDTA), methylglycine | |
| diacetic acid (MGDA); glutamic acid-N,N-diacetic acid (GLDA), as | |
| acids, neutralized salts or as monoethanolamine adducts) | |
| Optical brightener (such as 4,4′-Distyryl biphenyl types, FWA 5; | from 0 wt % to 2 wt % |
| FWA 7; FWA 11 and the likes) | |
| Formulated protease/s | from 0 wt % to 10 wt % |
| Formulated Amylase/s | from 0 wt % to 10 wt % |
| Formulated Lipoxygenase/s | from 0 wt % to 5 wt % |
| Formulated Lipase/s | from 0 wt % to 5 wt % |
| Other formulated enzyme (such as xyloglucanase, cutinase, pectate | from 0 wt % to 5 wt % |
| lyase, mannanase, bleaching enzyme) | |
| Formulated DNase/s | 0.000001-10% |
| Fabric softener (such as montmorillonite clay and/or | from 0 wt % to 4 wt % |
| polydimethylsiloxane (PDMS) | |
| Suds suppressor (such as silicone and/or fatty acid (as acids, | from 0 wt % to 10 wt % |
| neutralized salts or as monoethanolamine adducts)) | |
| Perfume (such as perfume microcapsule, perfume extract, liquid | from 0 wt % to 5 wt % |
| perfume, and any combination thereof) | |
| Aesthetics (such as opacifiers and colorants) | from 0 wt % to 2 wt % |
| Preservatives (such as isothiazolinones, phenoxyethanol) | From 0 wt % to 2 wt % |
| water | From 2 wt % to 15 wt % |
| others | optional |
| Filler (such as solvents) | balance |

TABLE 3
Powder detergent composition

| Ingredient | Amount (in wt %) |
|---|---|
| Anionic detersive surfactant (such as alkyl benzene sulphonate, alkyl | from 0 wt % to 30 wt % |
| ether sulphate, alpha-olefin sulphonate, methyl ester sulphonate | thereof) |
| and mixtures | |
| Non-ionic detersive surfactant (such as alkyl ethoxylated alcohol, | from 0 wt % to 10 wt % |
| alkylpoly glucosides; Glycereth-6 Laurate, biosurfactants, and mixtures) | |
| Other detersive surfactant (such as zwitterionic detersive | from 0 wt % to 4 wt % |
| surfactants, amphoteric surfactants, quaternary ammonium | |
| compounds and mixtures thereof) | |
| Carboxylate polymer (such as co-polymers of maleic acid and acrylic | from 0 wt % to 6 wt % |
| acid, polyacrylate, polycarboxylate and other PCA polymers, eg. | |
| Sokalan CP types, Acusol types, etc) | |
| Polyethylene glycol polymer (such as a polyethylene glycol polymer | from 0 wt % to 4 wt % |
| comprising poly vinyl acetate side chains) | |
| Polyester or terephthalate soil release polymer (such as | 0 to 2 wt % |
| Polypropylene/Polyethylene Terephthalate; Polyethylene | |
| Terephthalate; Sulfonated Polyethylene/Polyethylene Terephthalate | |
| anionic polyester, nonionic polymer, examples are the REPEL-O-TEX ® | |
| line of polymers (Solvay), including, REPEL-O-TEX ® SRP-6 and | |
| REPEL-O-TEX ® SF-2, Marloquest ® polymers, such as Marloquest ® SL | |
| (Sasol), and/or TexCare ® polymers like TexCare ® SRA 300 F (Clariant). | |
| Other polymer (such as amine polymers, dye PVP-NO/Polyvinyl | from 0 wt % to 10 wt % |
| Pyrrolidone N-oxide; Vinylpyrrolidone/vinylimidazole co-polymers, | |
| hexamethylenediamine derivative polymers, and mixtures thereof, | |
| e.g. Sokalan HP types, Sokalan K types | |
| Cellulosic polymer (such as carboxymethyl cellulose, cellulose gum, | from 0 wt % to 5 wt % |
| methyl cellulose and combinations thereof) | |
| Zeolite builder and phosphate builder (such as zeolite 4A and/or | from 0 wt % to 50 wt % |
| sodium tripolyphosphate) | |
| Other builder (such as sodium citrate and/or citric acid | from 0 wt % to 20 wt % |
| Carbonate salt (such as sodium carbonate and/or sodium bicarbonate) | from 0 wt % to 50 wt % |
| Silicate salt (such as sodium silicate) | from 0 wt % to 15 wt % |
| Source of available oxygen (such as sodium percarbonate) | from 0 wt % to 30 wt % |
| Bleach activator (such as tetraacetylethylene diamine (TAED) and/or | from 0 wt % to 15 wt % |
| nonanoyloxybenzenesulphonate (NOBS) | |
| Bleach catalyst (such as oxaziridinium-based bleach catalyst and/or | from 0 wt % to 0.5 wt % |
| transition metal bleach catalyst) | |
| Other bleach (such as reducing bleach and/or pre- formed peracid) | from 0 wt % to 10 wt % |
| Chelant (such as the phosphonates and aminocarboxylates | from 0 wt % to2 wt % |
| (ethylenediamine-N′N′-disuccinic acid (EDDS) and/or hydroxyethane | |
| diphosphonic acid (HEDP), diethylenetriamine penta(methylene | |
| phosphonic acid) (DTPMP), Diethylenetriamine-pentaacetic acid | |
| (DTPA), Ethylenediaminetetraacetic acid (EDTA), methylglycine | |
| diacetic acid (MGDA); glutamic acid-N,N-diacetic acid (GLDA)) | |
| Optical brightener (such as 4,4′-Distyryl biphenyl types, FWA 5; | from 0 wt % to 1 wt % |
| FWA 7; FWA 11 and the likes | |
| Photobleach (such as zinc and/or aluminium sulphonated phthalocyanine) | from 0 wt % to 0.5 wt % |
| Hueing agent (such as direct violet 99, acid red 52, acid blue 80, | from 0 wt % to 1 wt % |
| direct violet 9, solvent violet 13 and any combination thereof) | |
| Formulated protease/s | from 0 wt % to 5 wt % |
| Formulated Amylase/s | from 0 wt % to 1 wt % |
| Formulated Lipoxygenase/s | from 0.0 5 wt % to 5 wt % |
| Formulated Lipase/s | from 0 to 1 wt % |
| Other formulated enzyme (such as xyloglucanase, cutinase, pectate | from 0 wt % to 2 wt % |
| lyase, mannanase, bleaching enzyme) | |
| Formulated DNase/s | from 0 wt % to 5 wt % |
| Fabric softener (such as montmorillonite clay and/or | from 0 wt % to 4 wt % |
| polydimethylsiloxane (PDMS) | |
| Flocculant (such as polyethylene oxide) | from 0 wt % to 1 wt % |
| Suds suppressor (such as silicone and/or fatty acid) | from 0 wt % to 5 wt % |
| Perfume (such as perfume microcapsule, spray-on perfume, starch | from 0 wt % to 1 wt % |
| encapsulated perfume accords, perfume loaded zeolite, and any | |
| combination thereof) | |
| Aesthetics (such as colorants) | from 0 wt % to 1 wt % |
| Miscellaneous | from 0-5% each |
| Filler (such as sodium sulphate, sodium chloride and/or bio-fillers | balance |
| and/or water/solvents) | |

Surfactant ingredients can be obtained from BASF, Ludwigshafen, Germany (Lutensol®); Shell Chemicals, London, UK; Stepan, Northfield, Ill, USA; Huntsman, Huntsman, Salt Lake City, Utah, USA; Clariant, Sulzbach, Germany (Praepagen®).

Sodium tripolyphosphate can be obtained from Rhodia, Paris, France. Zeolite can be obtained from Industrial Zeolite (UK) Ltd, Grays, Essex, UK. Citric acid and sodium citrate can be obtained from Jungbunzlauer, Basel, Switzerland. NOBSis sodium nonanoyloxybenzenesulfonate, supplied by Eastman, Batesville, Ark., USA.

TAED is tetraacetylethylenediamine, supplied under the Peractive® brand name by Clariant GmbH, Sulzbach, Germany.

Sodium carbonate and sodium bicarbonate can be obtained from Solvay, Brussels, Belgium.

Polyacrylate, polyacrylate/maleate copolymers can be obtained from BASF, Ludwigshafen, Germany.

Repel-O-Tex® can be obtained from Rhodia, Paris, France.

Texcare® can be obtained from Clariant, Sulzbach, Germany. Sodium percarbonate and sodium carbonate can be obtained from Solvay, Houston, Tex., USA.

Na salt of Ethylenediamine-N,N′-disuccinic acid, (S,S) isomer (EDDS) was supplied by Octel, Ellesmere Port, UK.

Hydroxy ethane di phosphonate (HEDP) was supplied by Dow Chemical, Midland, Mich., USA.

Enzymes Savinase®, Savinase® Ultra, Stainzyme® Plus, Lipex®, Lipolex®, Lipoclean®, Celluclean®, Carezyme®, Natalase®, Stainzyme®, Stainzyme® Plus, Termamyl®, Termamyl® ultra, and Mannaway® can be obtained from Novozymes, Bagsvaerd, Denmark.

Enzymes Purafect®, FN3, FN4 and Optisize can be obtained from Genencor International Inc., Palo Alto, California, US.

Direct violet 9 and 99 can be obtained from BASF DE, Ludwigshafen, Germany. Solvent violet 13 can be obtained from Ningbo Lixing Chemical Co., Ltd. Ningbo, Zhejiang, China. Brighteners can be obtained from Ciba Specialty Chemicals, Basel, Switzerland.

All percentages and ratios are calculated by weight unless otherwise indicated. All percentages and ratios are calculated based on active concentration of the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Experimental

### Material

### Stains

Sunflower oil capsanthin linoleic acid stain 2 cm in diameter:

Capsanthin (80 mg, TCI), Linoleic acid (100 mg, Sigma, >99%) and Sunflower seed oil (500 mg, Sigma) are weighed out in a 200 mL beaker. In a fume hood acetone (31.5 mL) is added and mixed. 30 μL of this mixture is applied to textile (2 cm ø circle, Equest woven 100% cotton, pre-washed) and dried for 10 min. Stains are stored dark in a fridge until use.

Further, the following commercially available stains have been used in the laundry assays:
Textile sample C-04 Chlorophyl vegetable oil, C-S-15 Bill blueberry juice and C-S-88 Curry were obtained from Center for Testmaterials BV, P.O. Box 120, 3133 KT Vlaardingen, the Netherlands.
Textile samples WE5ECWKC Coffee, WE5FSMWKC french squeezy mustard, WE5RWWKC red wine and WE5TPWKC tomato puree were obtained from Warwick Equest.

### Enzymes

Lipoxygenase (LOX) is the polypeptide having SEQ ID NO:1. The soybean lipoxygenase is also available from Sigma-Aldrich (L-7395) and has CAS Number: 9029-60-1
Lipase is the polypeptide having SEQ ID NO:2
Medley SW 506T® and Medley Delicate 300L® are commercially available enzyme blends supplied by Novozymes A/S. Medley SW 506T® comprises amylase, mannanase, lipase, endoglucanase and pectate lyase. Medley Delicate 300L® comprises amylase, mannanase, endoglucanase and pectate lyase. Medley SW 506T® is a granulated product, whereas Medley Delicate 300L@ is a liquid product and they may in the Experimental section be abbreviated MD-T and MD-L, respectively.

### Intensity Measurement for Evaluation of Wash Performance

The wash performance is measured as the brightness expressed as the intensity of the light reflected from the sample when illuminated with white light. When the sample is stained the intensity of the reflected light is lower, than that of a clean sample. Therefore, the intensity of the reflected light can be used to measure wash performance.

Color measurements are made with a professional flatbed scanner (Kodak iQsmart, Kodak) used to capture an image of the washed textile.

To extract a value for the light intensity from the scanned images, 24-bit pixel values from the image are converted into values for red, green and blue (RGB). The intensity value (Int) is calculated by adding the RGB values together as vectors and then taking the length of the resulting vector:

Int=\sqrt{r²+g²+b²}

### Assay II: Testing of Lipase Activity

Lipase activity can be measured by use of colorimetric method based on the hydrolysis of p-Nitrophenyl-valerate and the formation of pNP can be monitored at 400 nM

### Enzyme Assays

### Assay I: Testing of Lipoxygenase Activity

Lipoxygenase activity may be determined spectrophotometrically at 25° C. by monitoring the formation of hydroperoxides. For the standard analysis, 10 micro liters enzyme is added to a1 ml quartz cuvette containing 980 micro liter 25 mM sodium phosphate buffer (pH 7.0) and 10 micro liter of substrate solution (10 mM linoleic acid dispersed with 0.2% (v/v) Tween20). The enzyme is typically diluted sufficiently to ensure a turn-over of maximally 10% of the added substrate within the first minute. The absorbance at 234 nm is followed and the rate is estimated from the linear part of the curve. The cis-trans-conjugated hydro(pero)xy fatty acids are assumed to have a molecular extinction coefficient of 23,000 M⁻¹ cm⁻¹.

### Recommended Dosages for Commercial Detergents

The table below provides an overview over recommended dosage of various commercially available liquid detergents. The recommended dosage is also in the context of the present disclosure also termed “full dosage” or “100% dosage”.

TABLE 4
Recommended detergent dosage from producer.

| | Recommended | | Recommended |
|---|---|---|---|
| Product | dosage | Product | dosage |
| Ariel Actilift | 55 mL | Persil Non-Bio | 35 mL |
| Colorwashmittel | | | |
| Ariel Universal | 55 mL | Omo Active | 65 mL |
| Strahlend Rein | | | |
| Ariel Baby | 55 mL | Persil 360 Coler Gel | 50 mL |
| Ariel Gel | 37 mL | Persil Universal Gel | 50 mL |
| Persil Colour | 35 mL | Tesco Colour Bio | 30 mL |
| Protect | | Liquid Super | |
| | | Concentrated | |

### Commercial Detergents Used in the Experiments

The commercial detergent Ecover non-bio Concentrated was used in the laundry experiments.

TABLE 5
Components in Ecover non-bio concentrated detergent
Ecover non-bio Concentrated laundry liquid

Aqua
Fatty alcohol ethoxylate C12-18
Sodium lauryl sulfate
Potassium oleate
Alcohol denatured
Sodium citrate
Trisodium Ethylenediamine Disuccinate
Polypropylene terephthalate
Perfume
Citric acid
Glycerin
Limonene
Linalool

For hand dish wash (HDW) the following two detergents were used:

TABLE 6
HDW Ecover Zero commercial detergent

| Compound | Content of compound (% w/w) |
|---|---|
| Anionic and non-ionic | 5-15% |
| surfactants | |

TABLE 7
HDW Vel commercial detergent

| Compound | Content of compound (% w/w) |
|---|---|
| Surface active compounds | 5-15% |
| Amphotoes surface | <5% |
| activecompounds | |
| Parfume | NA |
| Lactic acid | NA |

### Model Detergents Used in the Experiments

The following four model detergents have been used in the laundry experiments:

TABLE 8
Model 1 detergent

| Compound | Content of compound (% w/w) |
|---|---|
| LAS | 5.15 |
| AS | 5.00 |
| AEOS | 14.18 |
| Coco fatty acid | 1.00 |
| AEO | 5.00 |
| MEA | 0.30 |
| MPG | 3.00 |
| Ethanol | 1.50 |
| DTPA (as Na5 salt) | 0.25 |
| Sodium citrate | 4.00 |
| Sodium formate | 1.00 |
| Sodium hydroxide | 0.66 |
| H₂O, ion exchanged | 58.95 |

TABLE 9
Model 2 detergent

| Compound | Content of compound (% w/w) |
|---|---|
| Na-LAS | 12.0 |
| AEOS, SLES | 4.0 |
| Soap (KPO) | 3.0 |
| AEO | 12.0 |
| Ethanol | 3.1 |
| MPG | 2.0 |
| TEA | 2.0 |
| Sodium citrate | 3.9 |
| DTMPA | 1.5 |
| Phenoxy ethanol | 0.5 |
| H₂O, ion exchanged | 56.0 |

TABLE 10
Model 3 detergent

| Compound | Content of compound (% w/w) |
|---|---|
| SLS | 10.0 |
| APG | 8.0 |
| Coco soap | 4.0 |
| GLDA | 1.5 |
| Glycerol | 5.0 |
| EtOH | 5.0 |
| H₂O, ion exchanged | 66.5 |

TABLE 11
Model 4 detergent

| Compound | Content of compound (% w/w) |
|---|---|
| Na-LAS | 7.0 |
| Na-AS | 1.2 |
| Soap | 1.3 |
| AEO | 2.0 |
| Sodium carbonate | 15.0 |
| Sodium (di)silicate | 3.1 |
| Zeolite 4A + copoly(acrylic | 20.4 |
| acid/maleic acid) sodium salt | |
| HEDP-Na₄ | 0.15 |
| Sodium citrate | 2.0 |
| SRP (copolymer polyether/polyester) | 0.5 |
| Sodium sulfate | 46.3 |
| Silicone | 1.0 |

For automatic dish washing (ADWV) the following model detergent was used

TABLE 12
ADW Model detergent

| Compound | Content of compound (% w/w) |
|---|---|
| Sodium citrate | 20 |
| Sodium carbonate | 31 |
| Sodium percarbonate | 12 |
| Sodium silicate | 4 |
| Sodium sulfate | 24 |
| Acusol 588G (a sulfonated | 1 |
| polyacrylate available | |
| from Dow Inc.) | |
| TAED | 2 |
| Na-acetate trihydrate | 1 |
| Hydroxy Ethylidene Diphosphonic | 1 |
| Tetrasodium (Na-4-HEDP) | |
| Plurafac LF303 (alkoxylated, | 2 |
| predominantly unbranched fatty | |
| alcohols, and contains higher | |
| alkene oxides alongside ethylene | |
| oxide, available from BASF) | |

### Wash Assay

### Bottle Wash Method Description:

A bottle wash method in Miele washing machines was used to detect the performance of the enzymes. In a Miele washing machine (Softtronic W1935 Ecoline) was added bottles (60 mL, DSE PP 70X35 Aseptisk, material #: 216-2620, from VWR) with 25 mL detergent solution including enzyme(s) and four stained textiles (Sunflower-Capsanthin-Linoliec acid stains, 2 cm in diameter). Two kg ballast (tea towels, cotton) was included in the washing machine. Washed in 25 L water for 25 min at 30° C. in liquid detergent (Ecover non-bio) or water. After wash the stained textiles were rinsed with tap water twice (3 L) and dried overnight at room temperature in drying cabinet (Electrolux, Intuition, EDD2400). The intensity was measured on a spectrophotometer (Macbeth Color-Eye 7000 Remissions) at 460 nm.

TABLE 13
Test conditions for bottle wash method

| | |
|---|---|
| Wash method | Bottle wash in FSW machines, 2 cm circular |
| | Sunflower Oil-Capsanthin-Linoleic acid stain |
| | (woven cotton) |
| Detergent | Ecover non-bio concentrated (2.33 g/L (100%)) |
| Detergent dosing | 0%, 5%, 10%, 20% and 100% |
| Enzymes | LOX SEQ ID NO: 1 + Lipase SEQ ID NO: 2 |
| Conditions | 1: Blank |
| | 2: Lipase SEQ ID NO: 2 0.1 ppm |
| | 3: LOX SEQ ID NO: 1 2 ppm |
| | 4: LOX SEQ ID NO: 1 10 ppm |
| | 5: LOX SEQ ID NO: 1 2 ppm + Lipase |
| | SEQ ID NO: 2 0.1 ppm |
| | 6: LOX SEQ ID NO: 1 10 ppm + Lipase |
| | SEQ ID NO: 2 0.1 ppm |
| | 25 min |
| Temperature | 30° C. |
| Water hardness | 15°dH (ratio 4/1/7.5) |
| pH | As is |
| Drying | Room temperature over night |

### Terg-O-Tometer (TOM) Wash Assay

The Terg-O-tometer (TOM) is a medium scale model wash system that can be applied to test 16 different wash conditions simultaneously. A TOM is basically a large temperature-controlled water bath with up to 16 open metal beakers submerged into it. Each beaker constitutes one small top loader style washing machine and during an experiment, each of them will contain a solution of a specific detergent/enzyme system and the soiled and unsoiled fabrics its performance is tested on. Mechanical stress is achieved by a rotating stirring arm, which stirs the liquid within each beaker. Because the TOM beakers have no lid, it is possible to withdraw samples during a TOM experiment and assay for information on-line during wash.

Terg-o-tometer (TOM) wash performance of Lipoxygenase was tested in the European & North American liquid detergents Model 1, Model 2, Model 3 and European powder detergent Model 4 under the experimental conditions given in table 14. The number following the model number (e.g. 50 in Model 3-50) indicates percentage of full dosage. For detergent Model 3 full dosage would correspond to 2.46 g/L and Model 3-50 thus indicates that 50% of full detergent dosage was applied in the test. Concentrations are indicated in the wash liquor.

TABLE 14
Experimental conditions for TOM wash assay.

| | European conditions | North American conditions |
|---|---|---|
| Detergent dosage | Model 3-50: 1.23 g/L | Model 3-50: 1.23 g/L |
| | Model 2-10: 0.33 g/L | Model 1-35: 0.28 g/L |
| | Model 2-100: 3.33 g/L | |
| | Model 4-75: 0.36 g/L | |
| Lipoxygenase | 0 or 2 mg enzyme protein/L | 0 or 2 mg enzyme protein/L |
| concentration in | | |
| wash solution | | |
| Lipase concentration | 0 or 0.1 mg enzyme protein/L | 0 or 0.1 mg enzyme protein/L |
| in wash solution | | |
| Dosing of Medley | 0 or 67 mg/L | 0 or 1.3% (w/w) |
| Delicate 300L | | |
| Dosing of Medley | 0 or 7 mg/L | — |
| SW 506T | | |
| Linoleic acid | 1.5 mL/L | 1.5 mL/L |
| Water hardness | 6°dH (Ca²⁺:Mg²⁺:HCO₃⁻ = 4:1:7.5) or | 6°dH (Ca²⁺:Mg²⁺:HCO₃⁻ = 4:1:7.5) |
| | 15°dH (Ca²⁺:Mg²⁺:HCO₃⁻ = 4:1:7.5) | |
| Test solution volume | 1000 ml | 1000 ml |
| Wash time | 50 minutes | 20 minutes |
| Rotation | 120 rpm | 120 rpm |
| pH | as is | as is |
| Temperature | 30° C. | 30° C. |

Test materials were as follows:

| | |
|---|---|
| Test material | Textile sample C-04 Chlorophyl vegetable oil, C-S-15 Bill blueberry juice and |
| | C-S-88 Curry were obtained from Center for Testmaterials BV, P.O. Box 120, |
| | 3133 KT Vlaardingen, the Netherlands. Textile samples WE5ECWKC Coffee, |
| | WE5FSMWKC french squeezy mustard, WE5RWWKC red wine and |
| | WE5TPWKC tomato puree were obtained from Warwick Equest. |

The wash performance of Lipoxygenase was tested as described below.

The wash solutions were prepared by adjusting the water hardness to either 6°dH (Ca²⁺:Mg²⁺:HCO₃⁻=2:1:4.5) or 15°dH (Ca²⁺:Mg²⁺:HCO₃⁻=4:1:7.5) by addition of CaCl₂, MgCl₂ and NAHCO₃, adding the desired amount of detergent and adjusting the temperature to 30° C. in the buckets. The detergents were dissolved during magnet stirring for 10 minutes (wash solution was used within 30 to 60 min after preparation). The temperature and rotation in the water bath in the TOM were set to 30° C. and 120 rpm, respectively. When the temperature was adjusted according to settings (tolerance is +/−0.5° C.), 1000 mL of the wash solution was added to the TOM beakers.

Swatches (2 of each type) and enzymes were added to the beakers and washed for 20 or 50 minutes. Swatches were rinsed in cold tap water for 5 minutes. The swatches were sorted and dried between filter paper in a drying cupboard without heat overnight.

The wash performance was measured as the brightness of the color of the textile washed expressed in remission values (REM) or Intensity units. Remission measurements were made using a Macbeth 7000 Color Eye spectrophotometer. Each of the dry swatches was measured. As there is a risk of interference from the background, the swatches were placed on top of two layers of fabric during the measurement of the remission. The remission was measured at 460 nm. The UV filter was not included. An average result for remission for the swatches was calculated.

### Example 1: Effect of Detergent Concentration on Lipoxygenase Performance

Performance of lipoxygenase with and without the addition of lipase was tested at various detergent concentrations (bottle wash assay). The results clearly show that lipoxygenase has improved bleaching or removal benefits in water and in dilute detergent (5%, 10% % 20%) compared to full dosage detergent (100%), where there is additional cleaning effect of lipoxygenase. Combination of lipoxygenase and lipase can result in additional or synergy effect.

TABLE 15
Bleaching effect of lipoxygenase and lipoxygenase in
combination with lipase.

| | | | | | Lipase | Lipase |
|---|---|---|---|---|---|---|
| | | | | | 0.1 | 0.1 |
| | | Lipase | LOX | LOX | ppm + | ppm + |
| | | 0.1 | 2 | 10 | LOX | LOX |
| | Blank | ppm | ppm | ppm | 2 ppm | 10 ppm |
| 0% Ecover | 389 | 378 | 414 | 419 | 413 | 420 |
| non-bio | | | | | | |
| 5% Ecover | 394 | 379 | 413 | 419 | 415 | 417 |
| non-bio | | | | | | |
| 10% Ecover | 400 | 379 | 415 | 420 | 413 | 420 |
| non-bio | | | | | | |
| 20% Ecover | 374 | 377 | 391 | 417 | 395 | 414 |
| non-bio | | | | | | |
| 100% Ecover | 305 | 299 | 312 | 313 | 305 | 320 |
| non-bio | | | | | | |

LOX is SEQ ID NO: 1 and Lipase is SEQ ID NO: 2

### Example 2: Performance of Lipoxygenase in Powder Detergent with Linoleic Acid and Medley SW 506T Under European Conditions (6°dH and 15°dH, TOM Wash)

The performance of lipoxygenase in powder detergent on various stains (Tables 16 and 19) as well as the effect on re-deposition (Tables 18 and 21) was tested by the addition of the lipoxygenase to Medley SW 506T at 6°dH and 15°dH in Model detergent 4 at 75% of full dosage. Standard deviation of the measured performance is also included in the tables. The results clearly show the effect of lipoxygenase at reduced detergent level (0.36 g/L).

TABLE 16
Performance in Model detergent 4-75 with
linoleic acid (6° dH, Intensity)

| Intensity | | | | | | | |
|---|---|---|---|---|---|---|---|
| 6° dH | A | B | C | D | E | F | G |
| Blank | 309 | 310 | 387 | 393 | 351 | 354 | 345 |
| Medley SW | 309 | 310 | 391 | 395 | 367 | 362 | 358 |
| 506T | | | | | | | |
| LOX + | 314 | 317 | 395 | 422 | 367 | 381 | 370 |
| Medley SW | | | | | | | |
| 506T | | | | | | | |

A: Chlorophyl vegetable oil,
B: Bill blueberry juice,
C: Curry,
D: Sunflower oil w capsanthin
E: French squeezy mustard,
F: Red wine,
G: Tomato puree.
LOX is SEQ ID NO: 1.

TABLE 17
Standard deviation of performance in Model detergent
4-75 with linoleic acid (6° dH, Intensity)

| Intensity | | | | | | | |
|---|---|---|---|---|---|---|---|
| 6° dH | A | B | C | D | E | F | G |
| Blank | 4.6 | 1.4 | 3.5 | 2.6 | 2.6 | 3.7 | 3.5 |
| Medley SW | 4.3 | 1.3 | 4.5 | 3.3 | 1.5 | 3.0 | 6.0 |
| 506T | | | | | | | |
| LOX + | 2.2 | 4.2 | 2.8 | 1.5 | 3.2 | 2.2 | 4.3 |
| Medley SW | | | | | | | |
| 506T | | | | | | | |

A: Chlorophyl vegetable oil,
B: Bill blueberry juice,
C: Curry,
D: Sunflower oil w capsanthin
E: French squeezy mustard,
F: Red wine,
G: Tomato puree.
LOX is SEQ ID NO: 1.

TABLE 18
Lipoxygenase bleaching of re-deposits after wash in
Model detergent 4-75 with linoleic acid (6° dH,
Intensity). Intensity and Standard Deviation on
white parts of French Squeezy Mustard,
Tomato Puree and Red Wine stains.

| | White part | | | | | |
|---|---|---|---|---|---|---|
| | of French | | White part of | | White part of | |
| | Squeezy mustard | | Tomato puree | | Red Wine | |
| 6° dH | Intensity | StdDEV | Intensity | StdDEV | Intensity | StdDEV |
| Blank | 424 | 1.5 | 424 | 0.7 | 425 | 1.9 |
| Medley SW | 428 | 1.8 | 427 | 2.6 | 427 | 4.4 |
| 506T | | | | | | |
| LOX + | 433 | 1.6 | 435 | 0.4 | 431 | 2.2 |
| Medley SW | | | | | | |
| 506T | | | | | | |

LOX is SEQ ID NO: 1.

TABLE 19
Performance of lipoxygenase in Model detergent 4-75
with linoleic acid (15° dH, Intensity)

| Intensity | | | | | | | | |
|---|---|---|---|---|---|---|---|---|
| 15° dH | A | B | C | D | E | F | G | H |
| Blank | 297 | 311 | 372 | 362 | 360 | 335 | 339 | 348 |
| Medley SW | 297 | 310 | 375 | 359 | 358 | 345 | 340 | 349 |
| 506T | | | | | | | | |
| LOX + | 308 | 334 | 379 | 414 | 367 | 348 | 357 | 376 |
| Medley SW | | | | | | | | |
| 506T | | | | | | | | |

A: Chlorophyl vegetable oil,
B: Bill blueberry juice,
C: Curry,
D: Sunflower oil w capsanthin
E: Coffee
F: French squeezy mustard,
G: Red wine,
H: Tomato puree.
LOX is SEQ ID NO: 1.

TABLE 20
Standard deviation of performance in Model detergent
4-75 with linoleic acid (15° dH, Intensity)

| Intensity | | | | | | | | |
|---|---|---|---|---|---|---|---|---|
| 15° dH | A | B | C | D | E | F | G | H |
| Blank | 2.7 | 2.8 | 3.6 | 2.7 | 3.2 | 2.6 | 2.4 | 7.7 |
| Medley SW | 1.3 | 3.2 | 4.8 | 1.3 | 3.4 | 1.1 | 2.3 | 5.1 |
| 506T | | | | | | | | |
| LOX + | 1.5 | 1.5 | 1.1 | 1.5 | 3.5 | 2.6 | 2.7 | 6.3 |
| Medley SW | | | | | | | | |
| 506T | | | | | | | | |

A: Chlorophyl vegetable oil,
B: Bill blueberry juice,
C: Curry,
D: Sunflower oil w capsanthin
E: Coffee
F: French squeezy mustard,
G: Red wine,
H: Tomato puree.
LOX is SEQ ID NO: 1.

TABLE 21
Lipoxygenase bleaching of re-deposition on white part of swatch
(around the stain on French squeezy mustard) after wash in Model
detergent 4-75 at 15°dH with linoleic acid (15°dH, Intensity).

| | White part of French Squeezy mustard | |
|---|---|---|
| 15°dH | Intensity | StdDEV |
| Blank | 415 | 4.2 |
| Medley SW 506T | 421 | 1.2 |
| LOX + Medley SW 506T | 425 | 2.4 |

LOX is SEQ ID NO: 1.

Tables 18 and 21 show that the use of lipoxygenase prevents re-deposition of material stemming from the dissolved stains on the white part of the textile.

### Example 3: Performance of Lipoxygenase with and without Lipase in Liquid Detergents with Linoleic Acid and Medley Delicate 300L Under European Conditions (15°dH, TOM Wash)

The performance of lipoxygenase in liquid Model detergent 2 and 3 on various stains with was tested with and without the presence of lipase. The standard deviation for the performance results in Table 22 is listed in Table 23. By comparison of lipoxygenase performance in Model detergent 2 it becomes evident that lipoxygenase has no or very limited effect at 100% detergent concentration but a very good performance at reduced detergent level (10%).

TABLE 22
Lipoxygenase with or without lipase in liquid detergents
with linoleic acid and MD-L under EU conditions (15° dH).

| | | | | | | | | |
|---|---|---|---|---|---|---|---|---|
| Remission | | | | | | | | |
| (460 nm) | | | | | | | | |
| 15° dH | A | B | C | D | E | F | G | H |

Model detergent 3-50

| | | | | | | | | |
|---|---|---|---|---|---|---|---|---|
| Blank | 38 | 59 | 38 | 29 | 50 | 41 | 59 | 45 |
| Lipase | 38 | 59 | 37 | 29 | 50 | 37 | 59 | 43 |
| LOX | 39 | 60 | 39 | 29 | 54 | 44 | 61 | 53 |
| LOX + | 40 | 60 | 38 | 29 | 53 | 44 | 61 | 53 |
| Lipase | | | | | | | | |

Model detergent 2-10

| | | | | | | | | |
|---|---|---|---|---|---|---|---|---|
| Blank | 37 | 56 | 37 | 28 | 48 | 57 | 60 | 43 |
| Lipase | 38 | 56 | 37 | 28 | 50 | 54 | 60 | 42 |
| LOX | 39 | 62 | 39 | 29 | 52 | 64 | 65 | 45 |
| LOX + | 39 | 60 | 39 | 28 | 52 | 71 | 65 | 45 |
| Lipase | | | | | | | | |

Model detergent 2-100

| | | | | | | | | |
|---|---|---|---|---|---|---|---|---|
| Blank | 44 | 60 | 42 | 34 | 52 | 61 | 62 | 52 |
| Lipase | 44 | 61 | 41 | 34 | 52 | 57 | 60 | 52 |
| LOX | 44 | 61 | 43 | 34 | 53 | 64 | 65 | 56 |
| LOX + | 45 | 60 | 45 | 36 | 53 | 62 | 64 | 54 |
| Lipase | | | | | | | | |

LOX is SEQ ID NO: 1, lipase is SEQ ID NO: 2.
A: Chlorophyl vegetable oil,
B: Coffee,
C: Curry,
D: French Squeezy Mustard,
E: Fruit juice,
F: Sunflower oil w capsanthin,
G: Red wine,
H: Tomato puree

The standard deviation for the data provided in Table 22 is given below:

TABLE 23
Standard deviation of lipoxygenase with or without
lipase in liquid detergents with linoleic acid and
Medley Delicate 300L under EU conditions (15° dH)

| | | | | | | | | |
|---|---|---|---|---|---|---|---|---|
| Remission | | | | | | | | |
| (460 nm) | | | | | | | | |
| 15° dH | A | B | C | D | E | F | G | H |

Model detergent 3-50

| | | | | | | | | |
|---|---|---|---|---|---|---|---|---|
| Blank | 1.5 | 0.8 | 0.9 | 0.8 | 0.5 | 0.6 | 1.5 | 1.3 |
| Lipase | 0.5 | 0.6 | 0.8 | 0.7 | 1.3 | 0.5 | 0.6 | 0.8 |
| LOX | 1.1 | 1.2 | 0.4 | 1.0 | 0.5 | 2.2 | 1.0 | 5.3 |
| LOX + | 1.3 | 1.9 | 0.4 | 0.8 | 0.4 | 1.1 | 0.7 | 5.9 |
| Lipase | | | | | | | | |

Model detergent 2-10

| | | | | | | | | |
|---|---|---|---|---|---|---|---|---|
| Blank | 1.3 | 0.8 | 0.9 | 1.5 | 0.7 | 2.0 | 0.5 | 2.1 |
| Lipase | 1.7 | 1.7 | 0.7 | 1.0 | 1.2 | 1.4 | 0.9 | 2.4 |
| LOX | 1.1 | 1.5 | 2.4 | 0.6 | 0.3 | 1.5 | 0.5 | 1.0 |
| LOX + | 1.1 | 3.1 | 2.3 | 1.3 | 1.4 | 1.6 | 2.3 | 3.0 |
| Lipase | | | | | | | | |

Model detergent 2-100

| | | | | | | | | |
|---|---|---|---|---|---|---|---|---|
| Blank | 1.0 | 1.4 | 1.6 | 0.2 | 0.8 | 2.0 | 1.0 | 3.0 |
| Lipase | 1.2 | 0.3 | 1.1 | 1.3 | 1.4 | 3.1 | 1.5 | 2.3 |
| LOX | 1.8 | 0.4 | 1.0 | 0.9 | 0.6 | 2.9 | 1.0 | 2.4 |
| LOX + | 2.1 | 1.3 | 1.7 | 1.7 | 1.0 | 5.0 | 1.1 | 1.9 |
| Lipase | | | | | | | | |

A: Chlorophyl vegetable oil,
B: Coffee,
C: Curry,
D: French Squeezy Mustard,
E: Fruit juice,
F: Sunflower oil w capsanthin,
G: Red wine,
H: Tomato puree

Effect on re-deposition of stain material is provided below (Table 24):

TABLE 24
Lipoxygenase bleaching of re-deposition on white part
of swatch (around the stain on French squeezy mustard)
in liquid detergents with linoleic acid and Medley
Delicate 300L under EU conditions 15° dH)

| | Model | | Model | | Model | |
|---|---|---|---|---|---|---|
| | detergent | | detergent | | detergent | |
| | 1-50 | | 2-10 | | 2-100 | |
| | White part | | White part | | White part | |
| | of French | | of French | | of French | |
| | Squeezy | | Squeezy | | Squeezy | |
| | mustard | | mustard | | mustard | |
| | Remission | | Remission | | Remission | |
| | (460 | | (460 | | (460 | |
| 15° dH | nm) | StdDEV | nm) | StdDEV | nm) | StdDEV |
| Blank | 75 | 1.4 | 74 | 1.4 | 78 | 0.2 |
| Lipase | 75 | 1.7 | 74 | 1.7 | 78 | 0.9 |
| LOX | 83 | 1.3 | 79 | 0.7 | 85 | 3.8 |
| LOX + Lipase | 84 | 0.7 | 81 | 1.2 | 83 | 5.5 |

Table 24 show that the use of lipoxygenase prevents re-deposition of material stemming from the dissolved stains on the white part of the textile.

### Example 4: Performance of Lipoxygenase with and without Lipase in Liquid Detergents with Linoleic Acid and Medley Delicate 300L Under North American Conditions (6°dH, TOM Wash)

The performance of lipoxygenase on stain removal in liquid Model detergent 1 (35% of full dosage) and 3 (50% of full dosage) on various stains was tested with and without the presence of lipase. The results are shown in Table 25 and the standard deviation is listed in Table 26.

TABLE 25
Lipoxygenase with or without lipase in liquid detergents
with Linoleic Acid (LA) and Medley Delicate
300L (MD-L) under NA conditions (6° dH)

| | | | | | | | | |
|---|---|---|---|---|---|---|---|---|
| Remission | | | | | | | | |
| (460 nm) | | | | | | | | |
| 6° dH | A | B | C | D | E | F | G | H |

Model detergent 3-50

| | | | | | | | | |
|---|---|---|---|---|---|---|---|---|
| Blank + MD-L | 39 | 56 | 37 | 23 | 46 | 59 | 55 | 45 |
| Lipase + MD-L | 38 | 56 | 36 | 24 | 47 | 54 | 55 | 45 |
| LOX + MD-L | 40 | 59 | 39 | 23 | 48 | 63 | 58 | 48 |
| LOX + Lipase + | 39 | 59 | 37 | 23 | 49 | 63 | 59 | 49 |
| MD-L | | | | | | | | |

Model detergent 1-35

| | | | | | | | | |
|---|---|---|---|---|---|---|---|---|
| Blank + MD-L | 38 | 52 | 37 | 24 | 42 | 51 | 53 | 39 |
| Lipase + MD-L | 38 | 51 | 35 | 25 | 43 | 51 | 54 | 41 |
| LOX + MD-L | 39 | 53 | 37 | 24 | 44 | 60 | 53 | 42 |
| LOX + Lipase + | 40 | 54 | 37 | 25 | 43 | 60 | 56 | 42 |
| MD-L | | | | | | | | |

A: Chlorophyl vegetable oil,
B: Coffee,
C: Curry,
D: French Squeezy Mustard,
E: Fruit juice,
F: Sunflower oil w capsanthin,
G: Red wine,
H: Tomato puree
LOX is SEQ ID NO: 1, lipase is SEQ ID NO: 2

TABLE 26
Standard deviation of Lipoxygenase with or without
lipase in liquid detergents with linoleic acid and
Medley Delicate 300L under NA conditions (6° dH)

| | | | | | | | | |
|---|---|---|---|---|---|---|---|---|
| Remission | | | | | | | | |
| (460 nm) | | | | | | | | |
| 6° dH | A | B | C | D | E | F | G | H |

Model detergent 3-50

| | | | | | | | | |
|---|---|---|---|---|---|---|---|---|
| Blank + | 0.6 | 0.5 | 0.8 | 0.9 | 1.0 | 1.3 | 0.9 | 0.5 |
| MD-L | | | | | | | | |
| Lipase + | 0.4 | 1.0 | 0.5 | 0.8 | 0.7 | 2.5 | 0.6 | 1.1 |
| MD-L | | | | | | | | |
| LOX + | 0.6 | 1.3 | 0.2 | 0.6 | 0.2 | 2.3 | 0.6 | 1.3 |
| MD-L | | | | | | | | |
| LOX + | 0.8 | 0.9 | 1.2 | 1.1 | 0.8 | 1.8 | 1.0 | 1.1 |
| Lipase + | | | | | | | | |
| MD-L | | | | | | | | |

Model detergent 1-35

| | | | | | | | | |
|---|---|---|---|---|---|---|---|---|
| Blank + | 0.9 | 0.5 | 1.1 | 0.4 | 0.8 | 1.7 | 2.2 | 1.1 |
| MD-L | | | | | | | | |
| Lipase + | 1.3 | 1.9 | 0.4 | 0.5 | 1.4 | 1.0 | 1.5 | 0.8 |
| MD-L | | | | | | | | |
| LOX + | 1.5 | 0.5 | 1.2 | 0.5 | 1.3 | 2.6 | 0.7 | 1.4 |
| MD-L | | | | | | | | |
| LOX + | 1.7 | 0.7 | 0.5 | 0.5 | 0.6 | 2.3 | 2.4 | 2.1 |
| Lipase + | | | | | | | | |
| MD-L | | | | | | | | |

A: Chlorophyl vegetable oil,
B: Coffee,
C: Curry,
D: French Squeezy Mustard,
E: Fruit juice,
F: Sunflower oil w capsanthin,
G: Red wine,
H: Tomato puree

TABLE 27
Lipoxygenase bleaching of re-deposition on white part
of swatch (around the stain on French squeezy mustard)
in liquid detergents liquid detergents with linoleic
acid and Medley Delicate 300L under NA conditions (6°dH)

| | Model detergent 1-50 | | Model detergent 3-35 | |
|---|---|---|---|---|
| | White part of French | | White part of French | |
| | Squeezy mustard | | Squeezy mustard | |
| | Remission | | Remission | |
| 6°dH | (460 nm) | StdDEV | (460 nm) | StdDEV |
| Blank | 79 | 0.5 | 84 | 0.8 |
| Lipase | 80 | 0.6 | 82 | 2.2 |
| LOX | 87 | 0.7 | 88 | 0.1 |
| LOX + Lipase | 87 | 0.3 | 86 | 1.2 |

LOX is SEQ ID NO: 1,
lipase is SEQ ID NO: 2

The results show the effect of lipoxygenase on stain removal as well as on redeposition (Table 27).

### Example 5: Performance of Lipoxygenase in Automatic Dish Wash (ADW) and Hand Dish Wash (HDW) Detergents (Bottle Wash)

The performance of lipoxygenase in ADW and HDW was tested under the experimental conditions set out below in Table 28

TABLE 28
Experimental conditions for ADW and HDW in bottle wash

| | European conditions |
|---|---|
| Detergent | ADW Model detergent -50: 1.50 g/L + |
| dosage | Plurafac: 0.37 g/L |
| | ADW Model detergent-100: 2.99 g/L + |
| | Plurafac: 0.74 g/L |
| | HDW Ecover-50: 0.3 g/L |
| | HDW Ecover-100: 0.6 g/L |
| | HDW Vel-50: 0.25 g/L |
| | HDW Vel-100: 0.50 g/L |
| Lipoxygenase | 0 or 2 mg enzyme protein/L |
| concentration in | |
| wash solution | |
| Water hardness | ADW: 21°dH (Ca²⁺:Mg²⁺:HCO₃⁻ = 4:1:7.5) |
| | HDW: 15°dH (Ca²⁺:Mg²⁺:HCO₃⁻ = 4:1:7.5) |
| Test solution | 25 mL per bottle |
| volume | |
| Wash time | 25 minutes |
| pH | as is |
| Temperature | 30° C. |
| Test material | Sunflower oil capsanthin linoleic acid |
| | stain 2 cm in diameter |

Lipoxygenase is SEQ ID NO: 1

The effect of lipoxygenase in ADW powder detergent as well and in liquid HDW detergents was evaluated, data in Table 29.

TABLE 29
Lipoxygenase (SEQ ID NO: 1) in
powder ADW detergents (21°dH)

| | ADW Model detergent-50 | | ADW Model detergent-100 | |
|---|---|---|---|---|
| | Sunflower oil w capsanthin | | Sunflower oil w capsanthin | |
| 21°dH | Intensity | StdDEV | Intensity | StdDEV |
| Blank | 368 | 1.4 | 389 | 3.2 |
| LOX | 372 | 1.7 | 391 | 0.6 |

*Data from ADW Model detergent-50 were measured after 3 days of drying in the dark, whereas ADW Model detergent-100 were measured after 1 day of drying in the dark.
LOX is SEQ ID NO: 1

TABLE 30
Lipoxygenase (SEQ ID NO: 1) in liquid HDW detergents (15° dH)

| | HDW Ecover-50 | | HDW Ecover-100 | | HDW Vel-50 | | HDW Ecover-100 | |
|---|---|---|---|---|---|---|---|---|
| | Sunflower oil w | | Sunflower oil w | | Sunflower oil w | | Sunflower oil w | |
| | capsanthin | | capsanthin | | capsanthin | | capsanthin | |
| 15° dH | Intensity | StdDEV | Intensity | StdDEV | Intensity | StdDEV | Intensity | StdDEV |
| Blank | 363 | 3.0 | 366 | 3.8 | 364 | 2.0 | 394 | 2.8 |
| LOX | 369 | 5.5 | 377 | 4.4 | 380 | 3.2 | 402 | 2.6 |

*Data from HDW Ecover-50 and HDW Vel-50 were measured after 3 days of drying in the dark, whereas HDW Ecover-100 and HDW Ecover-100 were measured after 1 day of drying in the dark.

The data shows that adding lipoxygenase to a ADW detergent (commercial as well as model detergent) has a beneficial effect on the removal (bleaching) capsanthin stains.

### Example 6: Performance of Lipoxygenase in Detergent Comprising Sophorolipid and Rhamnolipid in Bottle Wash

The effect of lipoxygenase in a detergent comprising sophorolipid and rhamnolipid was evaluated under the following wash conditions listed in Table 31. The composition of the detergent is listed in Table 32. Results are listed in Table 33.

TABLE 31
Experimental conditions for lipoxygenase in in bottle wash.

| | European conditions |
|---|---|
| Detergent dosage | Sophoro- and Rhamnolipid detergent-20: 0.45 g/L |
| | Sophoro- and Rhamnolipid detergent-100: 2.24 g/L |
| Lipoxygenase | 0 or 2 mg enzyme protein/L |
| concentration in | |
| wash solution | |
| Water hardness | 15°dH (Ca²⁺:Mg²⁺:HCO₃⁻ = 4:1:7.5) |
| Test solution | 25 mL per bottle |
| volume | |
| Wash time | 25 minutes |
| pH | as is |
| Temperature | 30° C. |
| Test material | Sunflower oil capsanthin linoleic acid stain |
| | (described earlier) 2 cm in diameter |

TABLE 32
Sophoro- and Rhamnolipid containing detergent

| Compound | Content of compound (% w/w) |
|---|---|
| Sophorolipid | 2.9 |
| Rhamnolipid | 5.0 |
| Coco soap | 8.0 |
| GLDA | 1.5 |
| Glycerol | 10 |
| MGP | 5 |
| EtOH | 5.0 |
| CaCl₂ | 0.03 |
| Na-formate | 0.3 |
| H₂O, ion exchanged | 62.37 |

TABLE 33
Lipoxygenase in liquid laundry detergent (15°dH)

| | F0-20 | | F0-100 | |
|---|---|---|---|---|
| | Sunflower oil w capsanthin | | Sunflower oil w capsanthin | |
| | Remission | | Remission | |
| 15°dH | (460 nm) | StdDEV | (460 nm) | StdDEV |
| Blank | 44 | 1.7 | 45 | 2.1 |
| LOX | 50 | 1.6 | 46 | 1.8 |

The data shows that adding lipoxygenase to a detergent comprising sophorolipid and rhamnolipid has a beneficial effect on the removal (bleaching) capsanthin stains.

1. A method for bleaching or removing a stain on textile, the method comprising contacting the textile with a wash liquor, wherein the wash liquor comprises a polypeptide having lipoxygenase activity and further comprises from about 0 g detergent/L wash liquor to about 4 g detergent/L wash liquor, optionally one or more polyunsaturated fatty acids, such as linoleic acid, and optionally one or more additional enzymes.

2. The method according to claim 1, wherein the wash liquor comprises about 0.1-3.5 g/L detergent/L wash liquor.

3. The method according to claim 1, wherein the polypeptide having lipoxygenase activity is a soybean lipoxygenase.

4. The method according to claim 1, wherein the polypeptide having lipoxygenase activity is soybean lipoxygenase 1 (LOX-1).

5. The method according to claim 1, wherein the polypeptide having lipoxygenase activity has at least 60% sequence identity, e.g., at least 65% sequence identity, at least 70% sequence identity, at least 75% sequence identity, at least 80% sequence identity, at least 85% sequence identity, at least 90% sequence identity, at least 91% sequence identity, at least 92% sequence identity, at least 93% sequence identity, at least 94% sequence identity, at least 95% sequence identity, at least 96% sequence identity, at least 97% sequence identity, at least 98% sequence identity, at least 99% sequence identity, or even 100% sequence identity to the polypeptide of SEQ ID NO: 1.

6. The method according to claim 1, wherein the polypeptide having lipoxygenase activity is used in combination with at least one additional enzyme, wherein the at least one additional enzyme is selected from the group consisting of proteases, amylases, deoxyribonucleases, lipases, xyloglucanases, cutinases, pectinases, pectin lyases, xanthan endoglucanases, xanthan lyases, peroxidases, haloperoxygenases, catalases and mannanases.

7. The method according to claim 6, wherein polypeptide having lipoxygenase activity is used in combination with a lipase.

8. The method according to claim 6, wherein the lipase has at least 60% sequence identity, e.g., at least 65% sequence identity, at least 70% sequence identity, at least 75% sequence identity, at least 80% sequence identity, at least 85% sequence identity, at least 90% sequence identity, at least 91% sequence identity, at least 92% sequence identity, at least 93% sequence identity, at least 94% sequence identity, at least 95% sequence identity, at least 96% sequence identity, at least 97% sequence identity, at least 98% sequence identity, at least 99% sequence identity, or even 100% sequence identity to the polypeptide of SEQ ID NO: 2.

9. A detergent composition comprising a lipoxygenase, and one or more biosurfactants, wherein the biosurfactant is selected from the group consisting of rhamnolipid, sophorolipid and plant based biosurfactants, such as SLS, APG, AEO and SLES, optionally one or more polyunsaturated fatty acids and optionally at least one additional enzyme.

10. The detergent composition according to claim 9, wherein the lipoxygenase has at least 60% sequence identity, e.g., at least 65% sequence identity, at least 70% sequence identity, at least 75% sequence identity, at least 80% sequence identity, at least 85% sequence identity, at least 90% sequence identity, at least 91% sequence identity, at least 92% sequence identity, at least 93% sequence identity, at least 94% sequence identity, at least 95% sequence identity, at least 96% sequence identity, at least 97% sequence identity, at least 98% sequence identity, at least 99% sequence identity, or even 100% sequence identity to the polypeptide of SEQ ID NO: 1.

11. The detergent composition according to claim 9, wherein the at least one additional enzyme is selected from the group consisting of proteases, amylases, deoxyribonucleases, lipases, xyloglucanases, cutinases, pectinases, pectin lyases, xanthanases, peroxidases, haloperoxygenases, catalases and mannanases.

12. The detergent composition according to claim 9, wherein the lipase has at least 60% sequence identity, e.g., at least 65% sequence identity, at least 70% sequence identity, at least 75% sequence identity, at least 80% sequence identity, at least 85% sequence identity, at least 90% sequence identity, at least 91% sequence identity, at least 92% sequence identity, at least 93% sequence identity, at least 94% sequence identity, at least 95% sequence identity, at least 96% sequence identity, at least 97% sequence identity, at least 98% sequence identity, at least 99% sequence identity, or even 100% sequence identity to the polypeptide of SEQ ID NO: 2.

13. (canceled)

14. A method for bleaching a stain on textile comprising contacting the stain with a detergent composition of claim 9.

15. The method of claim 14, wherein the contacting is performed under wash conditions.


SEQUENCE LISTING (2 sequences)

SEQ ID NO: 1 - protein, 839 aa, Glycine max
MFSAGHKIKGTVVLMPKNELEVNPDGSAVDNLNAFLGRSVSLQLISATKADAHGKGKVGKDTFLEGINTSLPTLGAGESAFNIHFEWDGSMGIPGAFYIKNYMQVEFFLKSLTLEAISNQGTIRFVCNSWVYNTKLYKSVRIFFANHTYVPSETPAPLVSYREEELKSLRGNGTGERKEYDRIYDYDVYNDLGNPDKSEKLARPVLGGSSTFPYPRRGRTGRGPTVTDPNTEKQGEVFYVPRDENLGHLKSKDALEIGTKSLSQIVQPAFESAFDLKSTPIEFHSFQDVHDLYEGGIKLPRDVISTIIPLPVIKELYRTDGQHILKFPQPHVVQVSQSAWMTDEEFAREMIAGVNPCVIRGLEEFPPKSNLDPAIYGDQSSKITADSLDLDGYTMDEALGSRRLFMLDYHDIFMPYVRQINQLNSAKTYATRTILFLREDGTLKPVAIELSLPHSAGDLSAAVSQVVLPAKEGVESTIWLLAKAYVIVNDSCYHQLMSHWLNTHAAMEPFVIATHRHLSVLHPIYKLLTPHYRNNMNINALARQSLINANGIIETTFLPSKYSVEMSSAVYKNWVFTDQALPADLIKRGVAIKDPSTPHGVRLLIEDYPYAADGLEIWAAIKTWVQEYVPLYYARDDDVKNDSELQHWWKEAVEKGHGDLKDKPWWPKLQTLEDLVEVCLIIIWIASALHAAVNFGQYPYGGLIMNRPTASRRLLPEKGTPEYEEMINNHEKAYLRTITSKLPTLISLSVIEILSTHASDEVYLGQRDNPHWTSDSKALQAFQKFGNKLKEIEEKLVRRNNDPSLQGNRLGPVQLPYTLLYPSSEEGLTFRGIPNSISI

SEQ ID NO: 2 - protein, 269 aa, Thermomyces lanuginosus
EVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVRRRDIVKIEGIDATGGNNQPNIPDIPAHLWYFGLIGTCL